(19) United States
(12) Patent Application Publication
(10) Pub. No.: US 2018/0262967 A1
(43) Pub. Date: Sep. 13, 2018

(54) CONTROL APPARATUS, METHOD, A NON-TRANSITORY COMPUTER READABLE MEDIUM STORING A PROGRAM

(71) Applicant: NEC Corporation, Tokyo (JP)

(72) Inventor: Tatsuya SHIRAGAKI, Tokyo (JP)

(73) Assignee: NEC Corporation, Tokyo (JP)

(21) Appl. No.: 15/903,125

(22) Filed: Feb. 23, 2018

(30) Foreign Application Priority Data
Mar. 13, 2017 (JP) 2017-046968

(51) Int. Cl. H04W 40/04; H04W 40/02; H04W 88/16

(52) U.S. Cl. CPC H04W 40/04; H04W 40/24; H04W 88/16; H04W 40/026

(57) ABSTRACT

To connect a server providing an application service via a mobile network and a user apparatus through an appropriate route. A control apparatus 100 includes an acquisition unit 131 that acquires evaluation information of multiple routes configured between an application server and a user apparatus, the application server providing an application service via a mobile network, and the evaluation information being based on a metric between the application server and a node included in the mobile network, and a selection unit 133 that selects at least one route from among the multiple routes based on the evaluation information.

### BACKGROUND OF THE INVENTION

### 1. Technical Field

The present invention relates to a control apparatus, a method, and a non-transitory computer readable medium storing a program regarding application service provision via a mobile network.

The present application claims priority based on Japanese Patent Application No. 2017-46968, filed on Mar. 13, 2017, the contents of which are incorporated herein by reference.

### 2. Background Art

In recent years, there has been appeared service using an application for many mobile radio user terminals or user equipment (hereinafter, abbreviated to “UE”) to transmit and receive a large amount of data such as Internet of thing (IoT), machine-to-machine (M2M), augmented reality (AR), and moving picture viewing on a smartphone. Many applications are required to have a good real-time performance.

For example, in an application for a telephone or videophone, if there is a large time lag until a voice made by a user reaches a UE at the other end, talking at cross-purposes may occur due to a delay in transmission of sound like a conversation through satellite in a TV program, for example.

In a gaming application via a network, if a server receiving user operation data from the UE performs processing, and if it takes a long time for the UE to get the result of the processing, a real-time performance may not be ensured in some cases. In this case, even if the user of the UE tries to react to the result of the user operation, a scene in the game has already proceeded more forward, the user may not properly play the game.

In a trading application for a stock market, if a time when to obtain information affecting a stock price is delayed, a timing for trading lags behind the timing of other people, so that a money-making opportunity may be lost to make a loss.

In an AR application, information required for a place of the UE is transmitted to the UE. If the transmission of such information is significantly delayed, the UE would have already moved to another place at the time when the information reaches the UE. In this situation, the AR application may not be useful.

In an M2M application, for example, a self-driving application for a car, a long time may be taken for a process of delivering driving information to a server, and a process of delivering a result of the processing by the server to the car, in some cases. The car travels while such a time elapses, and therefore, delivered information would become old for the car and be not useful in some cases.

As described above, further delay reduction is demanded from various applications.

Hereinafter, a description is given using, as a system for a mobile network, a specification defined in Long Term Evolution/Evolved Packet Core (LTE/EPC, EPC was initially also referred to as System Architecture Evolution (SAE)) which is defined by the Third Generation Partnership Project (3GPP) in the 3GPP Release 8 or later (so-called the fourth generation radio communication system).

Here, when the UE is used to access an application server in a packet data network, an IP packet passes through a route as below.

Assuming the UE as a start point, first, data transmitted from the UE passes through a radio base station (eNodeB) in a range where a radio signal reaches (cover area). Next, the data transmitted from the UE passes through a serving gateway (S-GW) that accommodates radio services and serves as an anchor point for handover. Next, the data transmitted from the UE has to pass through a packet data network gateway (which is sometimes abbreviated to “PDN-GW”, but hereinafter, abbreviated to “P-GW”) in order to connect to the Internet. This is because the P-GW is a gateway connecting with an external network. Note that a description of the S-GW is omitted for the purpose of simple description.

Here, the UE continues to use the initially used P-GW even moving through various places. For this reason, the UE continuously moving may increase a distance from the UE to the P-GW. In such a case, the IP packet from the UE is transported to a distant P-GW, which increases a delay. If the delay is increased, an application required to have a real-time performance as described above may not provide a service, or a quality of the service is degraded, disadvantageously.

To deal with such problems, Patent Literature 1 (PTL 1) describes that when a mobile terminal is connected to a radio base station, the mobile terminal is connected with a P-GW nearest the radio base station, for example. To be more specific, PTL 1 describes that P-GW relocation is achieved by initializing a mobility event to newly connect with a P-GW nearest to the mobile terminal (relocation of local breakout: relocating a core node (P-GW) locally, specifically, in such a way as to use a P-GW nearest to the UE or a radio base station being used by the UE).

Patent Literature 2 (PTL 2) describes a local gateway that may perform local breakout. To be more specific, PTL 2 describes that a gateway is locally provided, and an IP access is made from the gateway to another network (Local IP Access: LIPA), or a traffic from the local toward the Internet is offloaded (Selected IP Traffic Offload: SIPTO).

Further, Patent Literature 3 (PTL 3) describes that a request router provided with a function to calculate, if a necessary bandwidth for data delivery cannot be acquired, whether an alternative route can be set between a relay server and a terminal, and a function, if a route can be set based on the result of the calculation, to explicitly set such a path.

[PTL 1] Published Japanese Translation of PCT International Publication for Patent Application, No. 2010-525681

[PTL 2] Published Japanese Translation of PCT International Publication for Patent Application, No. 2013-502121

[PTL 3] Japanese Laid-open Patent Publication No. 2004-48146

### SUMMARY OF THE INVENTION

However, the technologies disclosed in PTLs 1 and 2 or the like only reduce the delay between the UE and the P-GW, for example, and not necessarily reduce the delay between the UE and the server providing the application service. The technology disclosed in PTL 3 also gives no consideration for the application service via the mobile network.

An example object of the present invention is to provide a control apparatus, a method, and a non-transitory computer readable medium storing a program enabling connecting between a server providing an application service via a mobile network and a user apparatus through an appropriate route.

According an example aspect of the present invention, a control apparatus includes a memory storing a program; and one or more processors configured to execute the program to acquire evaluation information of multiple routes configured between a server and a user apparatus, the server providing at least one application service via a mobile network including at least one radio base station node and at least one connection node for connecting to other network, and the evaluation information being based on a metric between the server and a node included in the mobile network, and select a route that defines at least one node of the at least one radio base station node and the at least one connection node from among the multiple routes, based on the evaluation information.

According an example aspect of the present invention, a method according another includes acquiring evaluation information of multiple routes configured between a server and a user apparatus, the server providing at least one application service via a mobile network including at least one radio base station node and at least one connection node for connecting to other network, and the evaluation information being based on a metric between the server and a node included in the mobile network and selecting a route that defines at least one node of the at least one radio base station node and the at least one connection node from among the multiple routes, based on the evaluation information.

According an example aspect of the present invention, a non-transitory computer readable medium storing a program causes a processor to execute acquiring evaluation information of multiple routes configured between a server and a user apparatus, the server providing at least one application service via a mobile network including at least one radio base station node and at least one connection node for connecting to other network, and the evaluation information being based on a metric between the server and a node included in the mobile network and selecting a route that defines at least one node of the at least one radio base station node and the at least one connection node from among the multiple routes, based on the evaluation information.

According to the present invention, it is possible to connect a server providing an application service via a mobile network and a user apparatus through an appropriate route. Note that according to the present invention, instead of or together with the above effect, other effects may be exerted.

### BRIEF DESCRIPTION OF DRAWINGS

FIG. 1 is a block diagram illustrating a schematic configuration of an application service providing system.

FIG. 2 is an explanatory diagram illustrating an example of a schematic configuration of a system 1 according to an exemplary embodiment of the present invention.

FIG. 3 is a block diagram illustrating an example of a schematic configuration of a control apparatus 100 according to a first exemplary embodiment.

FIG. 4 is a configuration diagram illustrating a system configuration according to a basic configuration of an example.

FIG. 5 is a diagram illustrating a concrete configuration example of a network 911, which is a part of the system.

FIG. 6 is a diagram for describing an example of processing according to a first example.

FIG. 7 is a diagram illustrating a connection diagram after establishing a GTP tunnel.

FIG. 8 is a diagram for describing a processing example according to the first example.

FIG. 9 is a diagram for describing a processing example according to the first example.

FIG. 10 is a diagram for describing an example of processing according to a second example.

FIG. 11 is a diagram for describing an example of processing according to a third example.

FIG. 12 is a diagram for describing an example of processing according to a fourth example.

FIG. 13 is a diagram illustrating a schematic configuration example of a radio base station 202 according to the fourth example.

FIG. 14 is a diagram illustrating a schematic configuration example of the radio base station 202 according to the fourth example.

FIG. 15 is a diagram illustrating a schematic configuration example of the radio base station 202 according to the fourth example.

FIG. 16 is a diagram for describing an example of processing according to a fifth example.

FIG. 17 is a diagram for describing an example of processing according to a sixth example.

FIG. 18 is a diagram for describing an example of processing according to a seventh example.

FIG. 19 is a diagram for describing an example of processing according to an eighth example.

FIG. 20 is a diagram for describing an example of processing for updating an IP address of a UE in the eighth example.

FIG. 21 is a diagram for describing an example of processing according to a ninth example.

FIG. 22 is a diagram for describing an example of processing according to a tenth example.

FIG. 23 is a block diagram illustrating an example of a schematic configuration of a control apparatus 100 according to a second exemplary embodiment.

### DESCRIPTION OF THE EMBODIMENTS

Hereinafter, a description is given of exemplary embodiments of the present invention with reference to the accompanying drawings. Note that in the present description and drawing, the components capable of being explained in the same way may be denoted by the same reference signs and duplicated description may be omitted.

Description is given in the following order.

1. Related Art

2. Overview of Exemplary Embodiments of the Present Invention

3. Configuration of System

4. First Exemplary Embodiment
4.1. Configuration of Control Apparatus
4.2. Technical Features
4.3 Examples

5. Second Exemplary Embodiment
5.1. Configuration of Control Apparatus
5.2. Technical Features

6. Other Exemplary Embodiments

### 1. Related Art

As a technology relating to an exemplary embodiment of the present invention, an application service providing system providing an application service to a UE via a mobile network will be described.

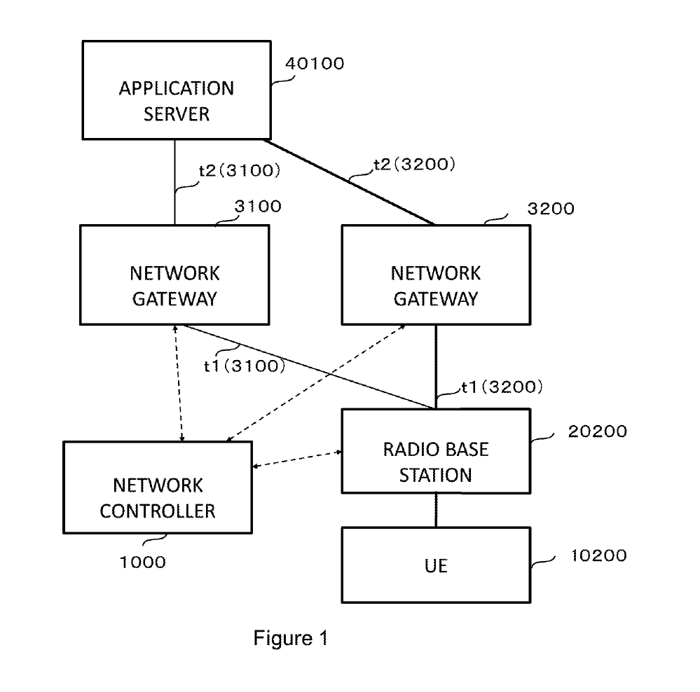

FIG. 1 is a block diagram illustrating a schematic configuration of an application service providing system. As illustrated in FIG. 1, the application service providing system includes a UE 10200, a radio base station 20200, a network gateways 3100 and 3200, an application server 40100, and a network controller 1000, for example.

The UE 10200 uses an application and transmits and receives data to and from an application server 40100 for the application. Concretely, the UE 10200 accesses the radio base station 20200 to communicate with the application server 40100 through the radio base station 20200.

Each of the network gateways 3100 and 3200 is a gateway connecting to an external network such as an Internet service provider (ISP) network. The UE 10200 can select the network gateway 3100 or network gateway 3200 to communicate with the application server 40100.

### 2. Overview of Exemplary Embodiments of the Present Invention

First, a description is given of an overview of exemplary embodiments of the present invention.

### (1) Technical Problem

In the application service providing system as illustrated in FIG. 1, for example, assume that a transfer time (including a data packet processing time) required from the radio base station 20200 to the network gateway 3100 is t1(3100), a transfer time required from the network gateway 3100 to the application server 40100 is t2(3100), a transfer time required from the radio base station 20200 to the network gateway 3200 is t1(3200), and a transfer time required from the network gateway 3200 to the application server 40100 is t2(3200).

Next, consider a case that an inequality sign is satisfied for each of Formulas 1 and 2 below.

t1(3100)>t1(3200) (Formula 1)

t1(3100)+t2(3100)<t1(3200)+t2(3200) (Formula 2)

Here, in a case that the network gateway 3100 is selected, a connection is made from the network gateway 3100 to the application server 40100, and a time required from the radio base station 20200 to the application server 40100 is t1(3100)+t2(3100). On the other hand, in a case that the network gateway 3200 is selected, a connection is made from the network gateway 3200 to the application server 40100, and a time required from the radio base station 20200 to the application server 40100 is t1(3200)+t2(3200).

As described above, a route between the UE 10200 and the application server 40100 corresponds to t1(3100)+t2(3100) or t1(3200)+t2(3200).

Here, considering only the transfer time between the UE 10200 and the network gateway 3100 or 3200, the UE 10200 is to select the network gateway 3100 through which a time required for transferring from the radio base station 20200 is shorter. If the network gateway 3100 is selected in this way, in terms of the inequality sign in Formula 2 above, it is clear that a network gateway through which a delay between the radio base station and the application server is minimum is not selected.

As described above, the delay between the UE and the server providing the application service cannot necessarily have been reduced by only reducing the delay between the UE and the network gateway. Similarly, a resource between the UE and the server providing the application service cannot necessarily have been optimized by only optimizing a resource between the UE and the network gateway.

An object of the exemplary embodiment according to the present invention is to enable connecting an application server providing an application service via a mobile network and a UE (user equipment or user apparatus) through an appropriate route.

### (2) Technical Feature

In the exemplary embodiment of the present invention, for example, acquired is evaluation information of multiple routes configured between a server and a user apparatus, the server providing at least one application service via a mobile network including at least one (i.e., one or multiple) radio base station nodes and at least one (i.e., one or multiple) connection nodes for connecting to other network, and the evaluation information being based on a metric between the server and a node included in the mobile network, a route that defines at least one node of the at least one radio base station node and the at least one connection node is selected from among the multiple routes based on the evaluation information.

This enables connecting between the server providing the application service via the mobile network and the user apparatus through an appropriate route, for example.

Note that the technical feature described above is a concrete example of the exemplary embodiment of the present invention, and, of course, the exemplary embodiment of the present invention is not limited to the technical feature described above.

### 3. Configuration of System

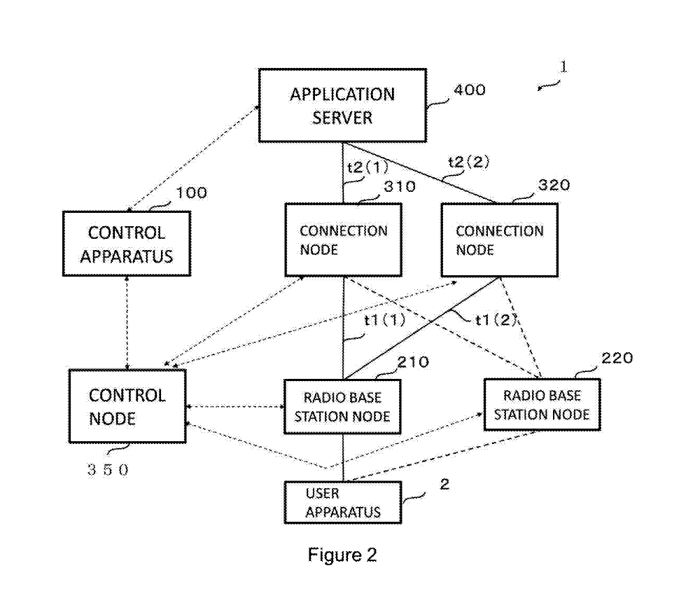

A description is given of an example of a configuration of a system 1 according to the exemplary embodiment of the present invention with reference to FIG. 2. FIG. 2 is an explanatory diagram illustrating an example of a schematic configuration of the system 1 according to the exemplary embodiment of the present invention. With reference to FIG. 2, the system 1 is a system for providing an application to a user apparatus 2 via a mobile network, and includes radio base station nodes 210 and 220, connection nodes 310 and 320 for connecting to other network outside the mobile network, a control node 350 of the mobile network, an application server 400, a user apparatus 2, and a control apparatus 100.

For example, assume that the system 1 performs communication using an Internet protocol (IP) packet defined by the Internet engineering task force (IETF) as a communication packet in a network layer. The system 1 includes a mobile network complying with the 3GPP (Third Generation Partnership Project) standards. To be more specific, the mobile network may be a network complying with LTE/LTE-Advanced and/or System Architecture Evolution (SAE). Alternatively, the mobile network may be a network complying with the fifth generation (5G) standards. Of course, the mobile network is not limited to these examples.

### (1) Radio Base Station Nodes 210 and 220

Each of the radio base station node 210 and 220 is a node of the mobile network. Concretely, each of the radio base station nodes 210 and 220 performs radio communication with a terminal apparatus (e.g. user apparatus 2) positioned in a coverage area.

### (2) Connection Nodes 310 and 320

Each of the connection node 310 and 320 is a node of the mobile network. Concretely, each of the connection nodes 310 and 320 is a node of a core network such as a network gateway (e.g., P-GW) and connected to other network outside the mobile network.

### (3) Control Node 350

The control node 350 is a control node of the mobile network and performs controls concerning the radio base station nodes 210 and 220, and the connection nodes 310 and 320. For example, the control node 350 is an MME as described below.

### (4) Application Server 400

The application server 400 performs processing regarding an application service. The application server 400 communicates with the user apparatus 2 through the connection node 310 or the connection node 320, and the radio base station node 210 or the radio base station node 220.

### (5) User Apparatus 2

The user apparatus 2 communicates with the radio base station nodes 210 and 220. The user apparatus 2 performs radio communication with the radio base station nodes 210 and 220. For example, the user apparatus 2 is a user equipment (UE).

### (6) Control Apparatus 100

The control apparatus 100 performs controls concerning a communication route between the application server 400 and the user apparatus 2 as concretely described below. For example, the control apparatus 100 communicates with the control node 350 and the application server 400 to perform the controls regarding the communication route.

### 4. First Exemplary Embodiment

Next, a description is given of a first exemplary embodiment of the present invention.

### 4.1. Configuration of Control Apparatus

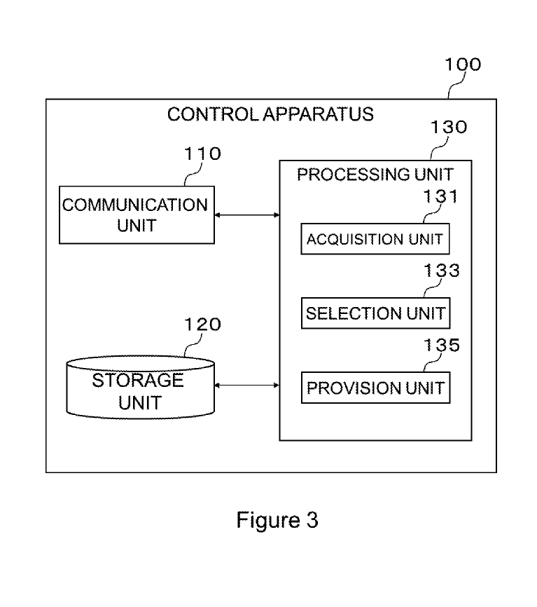

A description is given of an example of a configuration of the control apparatus 100 according to the first exemplary embodiment with reference to FIG. 3. FIG. 3 is a block diagram illustrating an example of a schematic configuration of the control apparatus 100 according to the first exemplary embodiment. With reference to FIG. 3, the control apparatus 100 includes a communication unit 110, a storage unit 120, and a processing unit 130.

### (1) Communication Unit 110

The communication unit 110 receives a signal from each of the application server 400 and the control node 350, and transmits a signal to each of the application server 400 and the control node 350, for example,

### (2) Storage Unit 120

The storage unit 120 transitorily or permanently stores a program (instructions) and parameters for an operation of the control apparatus 100, and various pieces of data. The program includes one or more instructions for an operation of the control apparatus 100.

### (3) Processing Unit 130

The processing unit 130 provides various functions of the control apparatus 100. The processing unit 130 includes an acquisition unit 131, a selection unit 133, and a provision unit 135. Note that the processing unit 130 may include other component than these components. In other words, the processing unit 130 may perform other operation than these components operations. Concrete operations of the acquisition unit 131, selection unit 133, and provision unit 135 are described below in detail.

For example, the processing unit 130 (acquisition unit 131) communicates with the user apparatus 2, the application server 400 and the like via the communication unit 110. For example, the processing unit 130 (provision unit 135) communicates with a node (e.g., control node 350) via the communication unit 110.

### (4) Implementation Example

The communication unit 110 may be implemented as a transmitting circuit and a receiving circuit, a network adapter, and/or a network interface card or the like. The storage unit 120 may be implemented as a memory (e.g., non-volatile memory, and/or volatile memory) and/or a hard disk or the like. The acquisition unit 131, the selection unit 133, and the provision unit 135 may be implemented on the same processor, or separately implemented on different processors. The above memory (storage unit 120) may be included in such a processor (chip).

The control apparatus 100 may include a memory storing a program (instructions) and one or more processors capable of executing the program (instructions), and the one or more processors may execute the program to perform the operation of the processing unit 130 (operations of the acquisition unit 131, selection unit 133, and provision unit 135). The above program may be a program causing the processor to execute the operation of the processing unit 130 (the operation of the acquisition unit 131, selection unit 133, and provision unit 135).

### 4.2. Technical Features

Next, a description is given of technical features in the first exemplary embodiment.

The control apparatus 100 (acquisition unit 131) acquires evaluation information of multiple routes configured between the application server 400 and the user apparatus 2, the application server 400 providing at least one application service via the mobile network including at least one radio base station node 210 or 220 and at least one connection node 310 or 320 for connecting to other network, and the evaluation information being based on a metric between the application server 400 and the node included in the mobile network. Then, the control apparatus 100 (selection unit 133) selects a route that defines at least one node of the at least one radio base station node 210 or 220 and the at least one connection node 310 or 320 from among the multiple routes, based on the evaluation information.

Here, the metric is a data transmission time, for example. Note that the metric is not limited to the data transmission time, but may include a processing time for the IP packet, the application and the like, or information other than the time information affecting the delay such as the number of hops. As the metric, information affecting the cost, for example, about a communication resource such as a bandwidth may be used.

According to the above configuration, by selecting the route based on the evaluation information based on the metric between the application server 400 and the node included in the mobile network, a more appropriate route can be selected as compared with a case of considering routes only between the user apparatus and respective connection nodes 310 and 320, for example. For example, in view of communication delay reduction, resource optimization and the like, it is possible to connect a server providing an application service via a mobile network and a user apparatus through an appropriate route.

### (1) Route Selection

For example, the selection unit 133 selects a route that defines any one node from among multiple connection nodes 310 and 320. To be more specific, the selection unit 133 selects the connection node 310 to select a route configured between the application server 400 and the user apparatus 2 via the connection node 310. In addition, the selection unit 133 selects the connection node 320 to select a route configured between the application server 400 and the user apparatus 2 via the connection node 320.

### (2) Evaluation Information

The evaluation information includes information regarding an optimal route having an optimal metric among the multiple routes.

For example, assume that a data transmission time between the radio base station node 210 with which the user apparatus 2 performs radio communication and the connection node 310 is t1(1), and a data transmission time between the radio base station node 210 with which the user apparatus 2 performs radio communication and the connection node 320 is t1(2). In addition, assume that a data transmission time between the connection node 310 and the application server 400 is t2(1), and a data transmission time between the connection node 320 and the application server 400 is t2(2).

Then, consider a case where an inequation such as t1(1)+t2(1)<t1(2)+t2(2) is satisfied between a data transmission time t1(1)+t2(1) of a route configured between the application server 400 and the radio base station node 210 via the connection node 310 and a data transmission time t1(2)+t2(2) of a route configured between the application server 400 and the radio base station node 210 via the connection node 320.

In this case, the evaluation information includes, as the optimal route (shortest route), information regarding a route configured between the application server 400 and the radio base station node 210 via the connection node 320. Concretely, the evaluation information includes information for identifying the connection node 320 connected on the optimal route (shortest route), particularly, an ID for uniquely identifying the connection node 320.

For example, the selection unit 133 can select, based on the evaluation information including the information identifying the connection node 320, a route configured between the application server 400 and the radio base station node 210 via the connection node 320.

Concrete Example of Evaluation Information Acquisition

The evaluation information is acquired by the acquisition unit 131 as below, for example.

### Concrete Example 1

For example, the acquisition unit 131 evaluates multiple routes based on the metric between the application server 400 and the nodes included in the mobile network (e.g., connection node 310 and 320) to generate and acquire the evaluation information.

### Concrete Example 2

The acquisition unit 131 may acquire the evaluation information based on identification information regarding the above application service. Here, the identification information regarding the application service refers to an application identifier and a content identifier, for example.

For example, as preprocessing, the acquisition unit 131 evaluates multiple routes for each piece of the identification information regarding the application service, based on the metric between the application server 400 and the nodes included in the mobile network (e.g., connection node 310 and 320) to generate and acquire the evaluation information. Then, information of a database associating the acquired evaluation information with the identification information regarding the application service is held in the storage unit 120, for example.

The information of the database being held through the preprocessing as described above allows the acquisition unit 131 to acquire the evaluation information associated with the identification information regarding the application service, when receiving the identification information regarding the application service from the user apparatus 2, the application server 400 or the like, for example.

### Concrete Example 3

The acquisition unit 131 may acquire the evaluation information based on identification information regarding the node included in the mobile network. Here, the identification information regarding the node included in the mobile network refers to, for example, an identifier of the radio base station if the node included in the mobile network is the radio base station node 210 or 220, or an identifier of the network gateway if the node included in the mobile network is the connection node 310 or 320, for example.

For example, as the preprocessing, the acquisition unit 131 evaluates multiple routes for each piece of the identification information regarding the node included in the mobile network, based on the metric between the application server 400 and the node included in the mobile network to generate and acquire the evaluation information. Then, information of the database associating the acquired evaluation information with the identification information regarding the node included in the mobile network is held in the storage unit 120, for example.

The information of the database being held through the preprocessing as described above allows the acquisition unit 131 to acquire the evaluation information associated with the identification information regarding the node included in the mobile network, when receiving the identification information regarding the node included in the mobile network from the user apparatus 2, the application server 400 or the like, for example.

### Concrete Example 4

The acquisition unit 131 may acquire the evaluation information based on positional information of the user apparatus. Here, the positional information of the user apparatus refers to positional information acquired by the user apparatus from a global positioning system (GPS), for example.

For example, as the preprocessing, the acquisition unit 131 evaluates multiple routes for each piece of the positional information of the user apparatus, based on the metric between the application server 400 and the node included in the mobile network to generate and acquire the evaluation information. Then, information of the database associating the acquired evaluation information with the positional information of the user apparatus is held in the storage unit 120, for example.

The information of the database being held through the preprocessing as described above allows the acquisition unit 131 to acquire the evaluation information associated with the positional information of the user apparatus, when receiving the positional information of the user apparatus from the user apparatus 2, the application server 400 or the like, for example.

### Modification Example

The acquisition unit 131 is not limited to concrete example 1 to concrete example 4 described above, but may acquire the evaluation information by combining any of concrete example 2 to concrete example 4, for example. For example, the acquisition unit 131 may acquire the evaluation information based on the identification information regarding the application service and the identification information regarding the node included in the mobile network.

### (3) Provision of Information Related to Route

The provision unit 135 provides information regarding the route selected based on the evaluation information to the node included in the mobile network. Concretely, the provision unit 135 provides the information regarding the route selected based on the evaluation information to the control node 350 included in the mobile network.

For example, the provision unit 135 provides information regarding a route configured between the application server 400 and the user apparatus 2 via the connection node 320 to the control node 350. In this case, the control node 350 can control the connection node 320 based on the provided information to transfer the data between the application server 400 and the user apparatus 2.

Note that the provision unit 135 may provide the information regarding the route selected based on the evaluation information to the node connected on the route selected based on the evaluation information. For example, the provision unit 135 may provide the information regarding the route configured between the application server 400 and the user apparatus 2 via the connection node 320 to the connection node 320. This allows the connection node 320 to transfer data received from the application server 400 to the user apparatus 2, and transfer data received from the user apparatus 2 to the application server 400.

### (4) Modification Example

For example, the system 1 is not limited to the case of including two radio base station nodes, but may include a single or multiple radio base station nodes. The system 1 is not limited to the case of including two connection nodes, but may include a single or multiple connection nodes.

For example, the node included in the mobile network may be virtualized. In this case, selecting the route that defines at least one node of the at least one radio base station node and the at least one connection node includes selecting a node virtualized in the mobile network.

The system 1 may include multiple application servers performing processing on the application service. In this case, selecting the route that defines at least one node of the at least one radio base station node and the at least one connection node includes selecting at least one application server of the multiple application servers providing the application service. For example, for the selection, the information regarding the optimal route may include information for identifying the server (application server) connected on the optimal route. Further, the provision unit 135 may provide the information regarding the route selected based on the evaluation information to the application server connected on the route selected based on the evaluation information.

The system 1 may provide multiple application services by use of at least one application server. In this case, the information regarding the optimal route may include information for identifying the application service provided via the optimal route.

### 4.3. Examples

Next, a description is given of examples to which the first exemplary embodiment is applied.

Basic Configuration

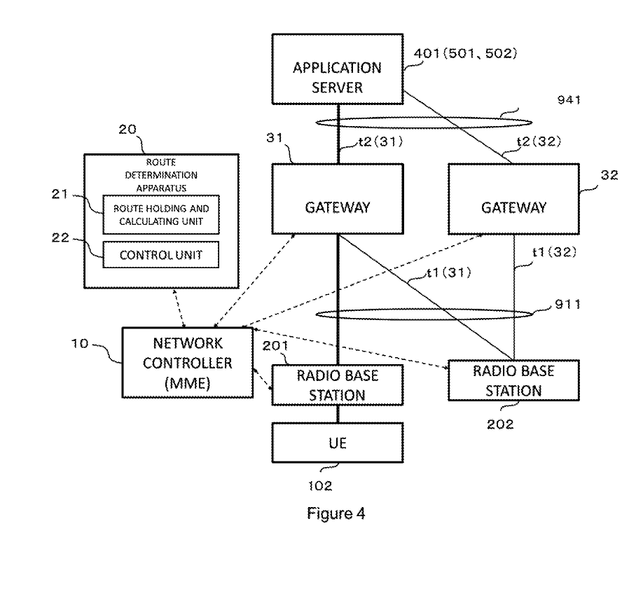

FIG. 4 is a configuration diagram illustrating a system configuration according to a basic configuration of each example.

In the basic configuration, an application server 401 for an application 501 provides an application service to a radio user terminal (UE 102) via a mobile network. Concretely, assume that the UE 102 transmits and receives information by means of the IP packet to and from mainly the remote application server 401 while operating the application 501.

The application 501 operated in the application server 401 includes an M2M application, an IoT application, moving picture distribution involving a large amount of communication traffics, a content distribution application, and IPTV which require the real-time performance.

The UE 102 is, for example, a terminal having a function to terminate LTE signals complying with a specification defined in Long Term Evolution/Evolved Packet Core (LTE/EPC) which is defined by the Third Generation Partnership Project (3GPP) as the 3GPP Release 8. As for LTE/EPC, reference literatures 1 and 2 below can be referred. Particularly as for an architecture, reference literature 1 below can be referred.

### REFERENCE LITERATURE 1

3GPP TS23.002 Rel-8 “Overview of 3GPP system architecture including EPC”
Reference literature 1 was disclosed at the following URL as of January 2015.
http://www.etsi.org/deliver/etsi_ts/123000_123099/123002/08.07.00_60/ts_1230 02v080700p.pdf

### REFERENCE LITERATURE 2

3GPP TS23.401 Rel-8 “EPC architecture using E-UTRAN”
Reference literature 2 was disclosed at the following URL as of January 2015.
http://www.etsi.org/deliver/etsi_ts/123400_123499/123401/08.18.00_60/ts_1234 01v081800p.pdf

Each of gateways 31 and 32 is a gateway of the mobile network connecting with a network outside the mobile network, for example, and performs forwarding of the IP packet for the external network. For example, the gateway 31 or 32 is a packet data network gateway (hereinafter, referred to as P-GW) defined in the 3GPP Release 8. The external network is typically a network of an Internet service provider (ISP). The P-GW has a function to configure a GTP tunnel for any section from the identical source node to the identical destination node included in communication traffics of the IP packet in order to connect with the radio base station. As for the GTP, reference literature 3 below can be referred.

### REFERENCE LITERATURE 3

3GPP TS29.060
Reference literature 3 was disclosed at the following URL as of January 2015.
http://www.etsi.org/deliver/etsi_ts/129000_129099/129060/08.16.00_60/ts_129060 v0816 00p.pdf

The gateway 31 or 32 may be a local gateway having the P-GW function provided in the radio base station or in a user home.

An identifier called an access point name (APN) is used for a name of a connection point that the gateway 31 or 32 connects with the external network. In a description of a first example below, assume that a single APN is used.

As for the APN, reference literature 4 below can be referred.

### REFERENCE LITERATURE 4

3GPP TS 23.003
“Technical Specification Group Core Network and Terminals; Numbering, addressing and identification”
Reference literature 4 was disclosed at the following URL as of January 2015.
https://tools.ietforg/html/rfc1546

For example, a network name of an ISP can be assigned to an APN to define a connection point of the ISP.

Note that as a gateway, besides the P-GW, a serving gateway (S-GW, see reference literatures 1 and 2 described above) may be provided between the radio base station and the P-GW. In a description of this basic example and drawings thereof, a description of the S-GW is omitted for the purpose of simple description.

The S-GW is usually provided to be associated with a tracking area (TA, see reference literatures 1 and 2 described above) managing a position of the UE 102. In other words, it can be considered that there is little room to examine selecting the S-GW because the S-GW used by the UE 102 is determined correspondingly to the radio base station used by the UE 102.

Radio base station 201 and 202 perform radio communication with the UE 102. Each of the radio base station 201 and 202 configures a radio channel for a UE (e.g., UE 102) located in a range where radio wave reach to enable the communication (cover area). Then, each of the radio base stations 201 and 202 transfers signals received from the UE 102 to a backhaul network (hereinafter, referred to as a network 911) through which the core network including the S-GW and the P-GW is connected.

As an example for the radio base stations 201 and 202, there can be used a radio base station according to the eNodeB specification defined by the 3GPP Release 8 defined in reference literatures 1 and 2 described above. Each of the radio base stations 201 and 202 includes a module terminating the GTP tunnel defined in reference literature 3 described above.

As illustrated in FIG. 4, the radio base stations 201 and 202 and the gateways 31 and 32 are connected via the network 911. The gateways 31 and 32 and the application server 401 are connected via a network 941.

Network connectivity illustrated in FIG. 4 represents a logical connectivity, and there are various physical achieving methods therefor.

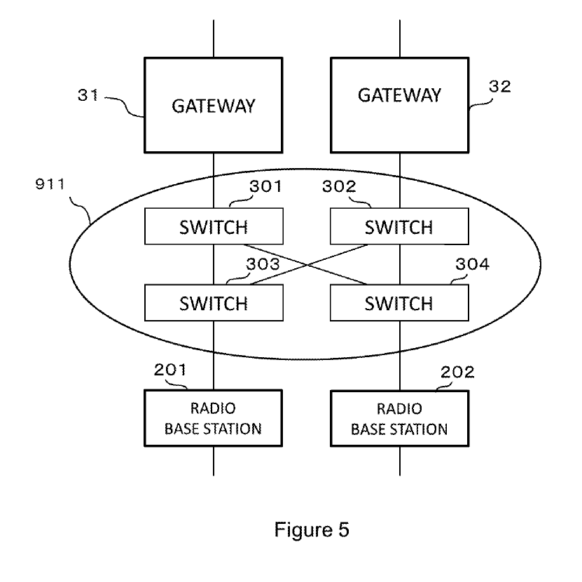

FIG. 5 is a diagram illustrating a concrete configuration example of the network 911, which is a part of the system. Each of switches 301, 302, 303, and 304 is a switch for switching a part of the IP packet. Each of the switches 301 to 304 refers to a destination IP address of an input IP packet to forward the input IP packet to an appropriate direction.

As the switches 301 to 304, a Layer 3 switch or the like can be used. Note that as the switches 301 to 304, an OpenFlow switch also can be used. In a case that the OpenFlow switch is used, each of the switches 301 to 304 can refer to information until Layer 4, to perform forwarding.

In the present example, assume that a configuration capable of multiple switching connections is implemented with the network having the configuration illustrated in FIG. 5.

As for the OpenFlow switch, reference literature 5 below can be referred.

### REFERENCE LITERATURE 5

OpenFlow Switch Specification Version 1.3.2
Reference literature 5 below was disclosed at the following URL as of January 2015.
https://www.opennetworking.org/images/stories/downloads/sdn-resources/onf-s pecifications/openflow/openflow-spec-v1.3.2.pdf

The network 941 can be achieved by combining multiple switches similarly to the configuration illustrated in FIG. 5.

The network controller 10 performs control regarding the radio base stations 201 and 202, and the gateways 31 and 32. Concretely, the network controller 10 is a mobility management entity (MME) defined in the 3GPP Release 8 (see reference literatures 1 and 2 described above).

A route determination apparatus 20 includes a route holding and calculating unit 21 and a control unit 22. The control unit 22 is one form of the control apparatus 100 describe above. In other words, the control unit 22 specifies an identifier (ID) of the application and an attribute of the radio base station, and then, determines an optimal gateway. The route holding and calculating unit 21 is one form of the storage unit 120 included in the control apparatus 100 described above. In other words, the route holding and calculating unit 21, in a case of using the identifier of the radio base station as the attribute of the radio base station, holds an identifier of a gateway through which a delay is the smallest for a combination of the application ID and the identifier (ID) of the radio base station 202.

Concretely, the route holding and calculating unit 21 can use the database to hold a correspondence relationship as indicated in Table 1, for example. In Table 1 and subsequent tables, conditions are specified in a column or columns on the left side of a double vertical line, and the evaluation information such as the gateway corresponding to the conditions is represented in a column or columns on the right side of the double vertical line.

For example, indicated is that when the UE 102 using the application 501 enters the cover area of the radio base station 201 to perform radio communication using the radio base station 201, a delay is reduced by way of the gateway 31, and thus, the gateway 31 is the optimal gateway (P-GW).

The route determination apparatus 20 has an interface receiving as inputs items in the column(s) on the left side of the double vertical line and an output interface returning items in the column(s) on the right side of the double vertical line corresponding to the inputs, for all tables described below including Table 1.

TABLE 1

| ID OF | | ID OF |
|---|---|---|
| APPLICATION | ID OF RADIO BASE STATION | GATEWAY |
| USED BY UE | USED BY UE | (P-GW) |
| APPLICATION 501 | RADIO BASE STATION 201 | GATEWAY 31 |
| | RADIO BASE STATION 202 | GATEWAY 31 |
| APPLICATION 502 | RADIO BASE STATION 201 | GATEWAY 31 |
| | RADIO BASE STATION 202 | GATEWAY 32 |

The correspondence relationship as indicated in Table 1 can be obtained by calculating a time required from each of the radio base station 201 and 202 to the application server 401 and comparing the calculated times. For example, from the viewpoint of the radio base station 202, a gateway to which the radio base station 202 can connect or which is to be a connection candidate includes the gateways 31 and 32.

Assuming that a time required for transferring the IP packet from the radio base station 202 to the gateway 31 is t1(31), a time required for transferring the IP packet from the gateway 31 to the application server 401 is t2(31), a time required for transferring the IP packet from the radio base station 202 to the gateway 32 is t1(32), and a time required for transferring the IP packet from the gateway 32 to the application server 401 is t2(32), a time required for transferring the IP packet from the radio base station 202 to the application server 401 is t1(31)+t2(31) through the gateway 31 or t1(32)+t2(32) through the gateway 32.

Here, consider a case that Formula 3 or Formula 4 is satisfied.

t1(31)+t2(31)<t1(32)+t2(32) (Formula 3)

In the case that (Formula 3) is satisfied, a route through the gateway 31 is less in delay than a route through the gateway 32.

t1(31)+t2(31)>t1(32)+t2(32) (Formula 4)

In the case that (Formula 4) is satisfied, the route through the gateway 32 is less in delay than the route through the gateway 31.

Here, if (Formula 3) is satisfied, and the UE 102 using the application 501 is in the cover area of the radio base station 202 as indicated in Table 1, the gateway 31 is relatively less in delay. Therefore, in this case, the gateway 31 corresponding to both the application 501 and the radio base station 202 can be determined according to Table 1.

In this way, measuring the respective required times between the radio base station and the gateway and between the gateway and the application server allows the optimal route, i.e., the gateway (P-GW) on the optimal route to be determined in advance for the combination of the application and the radio base station. The route holding and calculating unit 21 holds the information of such a correspondence relationship. The control unit 22 can refer to the route holding and calculating unit 21 based on the application ID and the radio base station ID input to the route determination apparatus 20 to select the optimal route, i.e., the gateway on the optimal route. Then, the control unit 22 can provide the ID of the selected gateway to the network controller 10.

As described above, in selecting the gateway (P-GW), assuming that the metric from the radio base station to the gateway (P-GW) is t1 and the metric from the gateway (P-GW) to the application server is t2, the gateway (P-GW) in a case that t1±t2 is minimum, i.e., in a case that the metric is the smallest (optimal) may be selected.

As described above, in the case of aiming at minimization of the delay, a time for delivery t1 for the IP packet between the radio base station and the gateway (P-GW) and a time for delivery t2 for the IP packet between the gateway (P-GW) and the application server may be used as the metrics.

The metric may include a processing time of the IP packet, the application, and the like other than the above described time for delivery. The time information described above can be measured by transmitting a ping message in an IP network.

Note that some applications may not be completed by the processing only by one server, and require processing serially by multiple servers. In this case, t2 may be a time obtained by totaling the processing times of the multiple servers. In addition, t2 may not be limited to the case of routing through one external network, but may also apply to a case of routing through multiple external networks.

The exemplary embodiment is not limited to the route selection capable of minimalizing the delay. For example, different metrics can be used. For example, an inverse number of a bandwidth for a link between the nodes is used as a cost, and a route through which this cost is reduced can be selected. In other words, a route, specifically, gateway (P-GW), in which the number of resources to be used is the smallest may be selected. According to the exemplary embodiment, as compared with the case that the number of resources between the radio base station and the gateway (P-GW) is only minimized, for example, the resources to be used in the entire route can be optimized with taking into account resources from the gateway to the application server.

In order to appropriately maintain the correspondence relationship as indicated in Table 1 regardless of time elapsed, if IP address information (positional information) of the application server is changed or added, such change or addition may be notified to the route determination apparatus 20.

The network controller 10 has a communication channel for transmitting and receiving control information to and from the radio base stations 201 and 202, the UE 102, the gateway 31, and the gateway 32, and uses the communication channel to transmit and receive the control information. Concretely, the respective devices physically connect with each other, and can transmit and receive an IP packet to which the destination IP address is specified by having a function to process the IP packet.

### (1) First Example

A description is given of an operation according to a first example of the present invention with reference to FIG. 4 and the like.

First, as illustrated in FIG. 4, the UE 102 is in the cover area of the radio base station 201 and uses the application 501. The gateway 31 is used as a gateway (P-GW). The signal from UE 102 is routed from the UE 102 through the radio base station 201 and the gateway 31 to the application server 401.

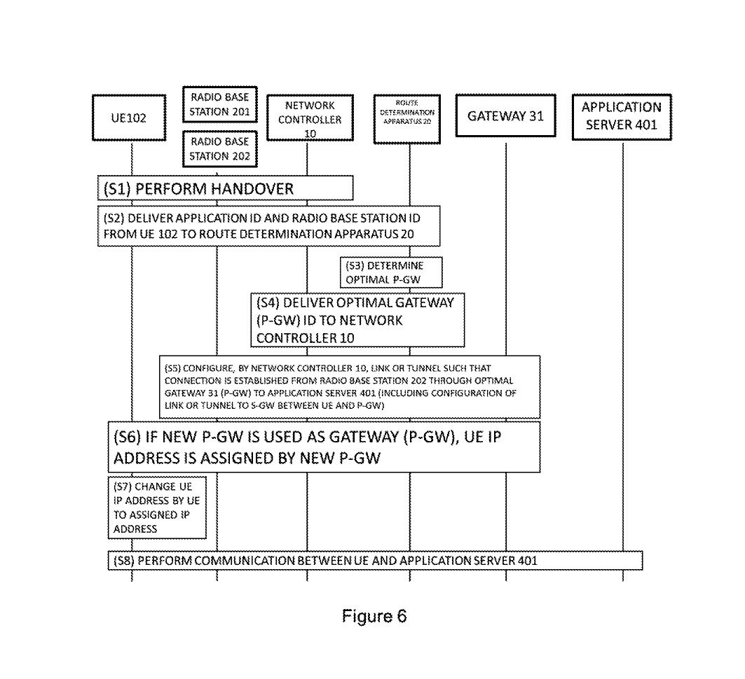

Next, when the UE 102 moves and enters the cover area of the radio base station 202, the network controller 10 determines to perform handover from the radio base station 201 to the radio base station 202 in terms of a radio field strength or the like. FIG. 6 is a diagram for describing processing according to the first example. A description is given of operations between the apparatuses with reference to FIG. 6.

Step S1

In the case of the handover from the radio base station 201 to the radio base station 202 due to the UE 102 moving, the handover is performed in accordance with the method in the 3GPP Release 8 described in reference literatures 1 and 2 described above.

Step S2

After the handover completes, the completion of the handover triggers that the UE 102 delivers the ID of the application being used by the UE 102 and the ID of the radio base station being used by the UE 102 to the route determination apparatus 20. Note that the UE 102 may deliver to the route determination apparatus 20 through the network controller 10, or may directly communicate with the route determination apparatus 20.

For example, in the case of through the network controller 10, i.e., in a case that the information of the application ID and content ID is delivered between the UE 102 and the network controller 10, the control information can be communicated between the UE 102 and the network controller 10 by using a non-access-stratum (NAS) protocol defined in reference literature 6 below, or by defining a storing scheme for data dedicated for the information, for example.

### REFERENCE LITERATURE 6

“Non-Access-Stratum (NAS) protocol for Evolved Packet System (EPS)” 3GPP TS 24.301
Reference literature 6 was disclosed at the following URL as of January 2015.
http://www.etsi.org/deliver/etsi_ts/124300_124399/124301/10.03.00_60/ts_1243 01v100300p.pdf

The application ID and the ID of the handover destination radio base station which are received by the network controller 10 using the above protocol are transferred from the network controller 10 to the route determination apparatus 20.

The information may be transmitted from the UE 102 directly to the route determination apparatus 20 without using the NAS protocol described in reference literature 6 above. In this case, a method by use of the GTP tunnel or a method of transferring by way of the IP packet assigned with an IP address of the route determination apparatus 20 using the same IP address space may be used between the UE 102 and the route determination apparatus 20.

The route determination apparatus 20 first receives, by the control unit 22, the IP packet addressed to the route determination apparatus 20. Then, the control unit 22 recognizes the ID of the application to be used by the UE 102 and the ID of the radio base station being used by the UE 102 which are included in the IP packet. The control unit 22 holds the received application ID and radio base station ID in a memory or the like provided in the control unit 22, for example.

As the application ID, used is a name space for an application ID, or a combination of an IP address and a port number of the application server 401, for example.

The application ID and the radio base station ID are not limited to the case of transmitting from UE 102 to the route determination apparatus 20. For example, if there is a device recognizing these IDs, the device may transmit the IDs to the route determination apparatus 20. For example, when the application server 401 grasps that the UE 102 uses the application 501 and uses the radio base station 202, the application server 401 may transmit the grasped information to the route determination apparatus 20.

Step S3

The route determination apparatus 20 (control unit 22) refers to the correspondence relationship in Table 1 held by the route holding and calculating unit 21, selects, for the combination of the application ID and the radio base station ID notified at step S2, the gateway through which a delay is the lowest until reaching the application server 401, i.e., the ID of the optimal gateway (P-GW's ID), and holds the gateway ID in an internal memory of the control unit 22.

If the UE 102 is using the application 501 and the radio base station 202, the control unit 22 refers to the relationship in Table 1 held by the route holding and calculating unit 21 to maintain information indicating that the optimal gateway is the gateway 31.

Step S4

The route determination apparatus 20 (control unit 22) notifies the network controller 10 of information for transferring the IP packet between the UE 102 and the application 501 by using the gateway 31. Concretely, the control unit 22 creates a message indicating that the optimal gateway through which a delay is the lowest for the IP packet carrying the communication of the application 501 for the UE 102 is the gateway 31. Then, the control unit 22 transmits this message to the network controller 10.

Note that if only the application 501 of the applications used by the UE 102 requires a real-time performance, IP packets for other applications may be routed through any gateway.

Step S5

Once the network controller 10 receives from the route determination apparatus 20 the information indicating that the gateway 31 is selected, the controller 10 configures a link or tunnel for the IP packet between the radio base station 202 and the gateway 31 such that a connection is established from the radio base station 202 through the gateway 31 to the application server 401.

The network controller 10 can utilize a function of the mobility management entity (MME) defined in the 3GPP Release 8 to configure the GTP tunnel.

In a case that the GPRS tunneling protocol (GTP) is used to configure a tunnel, a configuration for terminating the GTP is made in each of the radio base station 202 and the gateway 31. Here, there is the S-GW between the radio base station and the gateway (P-GW). Therefore, in accordance with the 3GPP Release 8, a GTP tunnel is configured between the radio base station 202 and the S-GW, and a GTP tunnel is configured between the S-GW and the gateway 31(P-GW). This configures connections at Layer 2 and Layer 3 levels.

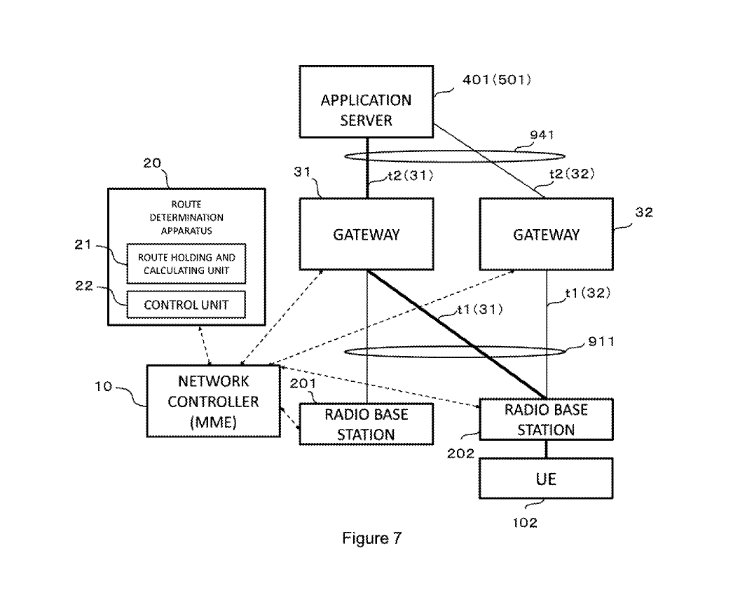

FIG. 7 is a diagram illustrating a connection diagram after establishing a GTP tunnel. As illustrated in FIG. 7, the GTP tunnel is configured between the radio base station 202 and the gateway 31 (P-GW). In FIG. 7, the S-GW is omitted for the purpose of simple description.

As described above, for the IP packet between the UE 102 and the application 501, selected is a route as illustrated in FIG. 7, i.e., a route connecting the UE 102, the radio base station 202, the gateway 31 (P-GW), and the application server 401.

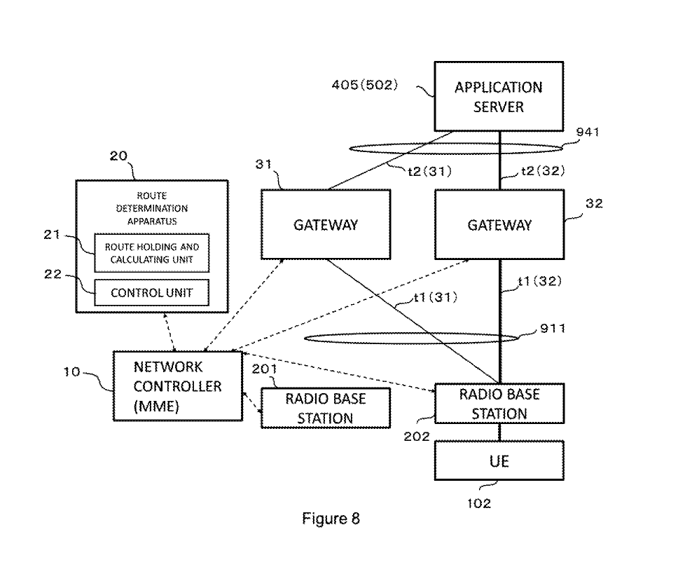

As illustrated in FIG. 8, in the case that the UE 102 uses the application 502, at step S3 described above, the route determination apparatus 20 (control unit 22) refers to the route holding and calculating unit 21 to see that the optimal gateway (P-GW) is the gateway 32 in accordance with the relationship in Table 1, and then, selects the gateway 32 at step S4 and subsequent steps. Then, the network controller 10 configures a link or tunnel between the radio base station 202 and the gateway 32 (P-GW). As described above, selected is a route as illustrated in FIG. 8, i.e., a route connecting the UE 102, the radio base station 202, the gateway 32 (P-GW), and the application server 401.

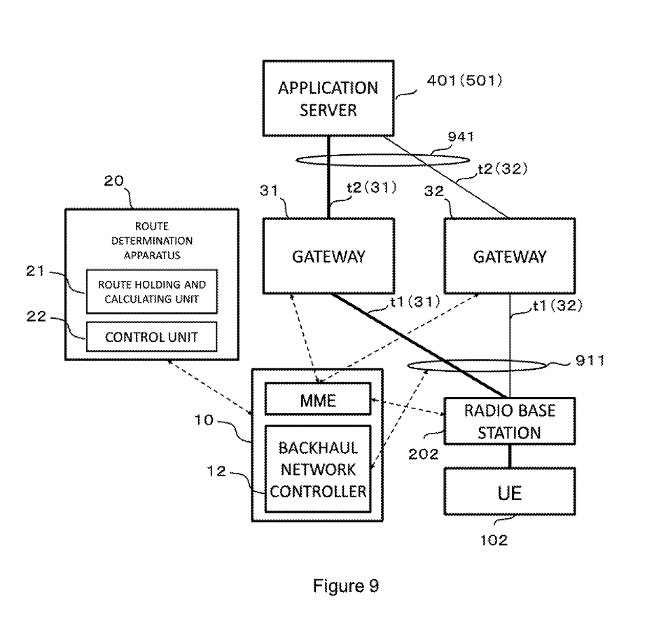

As illustrated in FIG. 9, the network controller 10 may include a backhaul network controller 12 controlling the backhaul network, in addition to the MME. The network between the radio base station and the gateway may be controlled to configure a bearer of the communication channel for the IP packet between the radio base station 202 and the gateway 31 (P-GW). Example of a bearer includes a physical layer, and examples of Layer 1 include an optical fiber connection, an optical path, or a communication path according to SDH. As a communication path, the switches 301 to 304 illustrated in FIG. 5, concretely, an optical switch and a cross-connect switch of the SDH path may be used, for example.

As for the optical path and the SDH path, reference literatures 7 and 8 below can be referred, respectively.

### REFERENCE LITERATURE 7

ITU-T G.709: Interfaces for the optical transport network
ITU-T: International Telecommunication Union Telecommunication Standardization Sector
Reference literature 7 was disclosed at the following URL as of January 2015.
http://www.itu.int/rec/T-REC-G.709/en

### REFERENCE LITERATURE 8

ITU-T G.707: Network node interface for the synchronous digital hierarchy (SDH)
Reference literature 8 was disclosed at the following URL as of January 2015.
http://www.itu.int/rec/T-REC-G.707/en

The network controller 10 may include an OpenFlow controller, in addition to the MME. In other words, if OpenFlow switches are used as the switches 301 to 304 illustrated in FIG. 5, content of L1 to L4 in the IP packet can be monitored to switch a forwarding destination.

The backhaul network controller 12 may combine multiple OpenFlow controllers described above, optical path controllers, and SDH path controllers to control Layer 1 through Layer 4 (layers in OSI 7 layer, Layer 1: physical layer, Layer 2: data link layer, Layer 3: network layer, and Layer 4: transport layer).

In a method different from the method using the tunnel, the application ID, the content ID and the like may be superimposed on the IP packet such that these IDs are monitored by the switch to switch a transfer destination (forwarding destination). This allows the IP packet to be switched for each application and for each content.

As describe above, the route determination apparatus 20 notifies the network controller 10 of the selected gateway (P-GW). Then, the network controller 10 determines what tunnel is to be configured between the radio base station 202 and the gateway (P-GW) in order to use the gateway (P-GW).

As an alternative method, the route determination apparatus 20 (control unit 22) may determine what tunnel is to be configured. In order to make various layers operate, link switching or tunnel configuration is needed depending on the respective layers. For this reason, the control unit 22 may have a control link determining function to determine how the connection between the determined gateway (P-GW) and the radio base station is configured in each layer.

Concretely, when the route determination apparatus 20 selects to use the gateway 31 (P-GW) in the case that the UE 102 using the application 501 uses the radio base station 202, for example, the device 20 also determines the link or tunnel between the radio base station 202 and the gateway 31 (P-GW). Then, the route determination apparatus 20 delivers the link or tunnel required in using the determined gateway to the network controller 10. The network controller 10 (MME) controls to configure the link or tunnel delivered from the route determination apparatus 20. Once the link or tunnel is configured, the process proceeds to step S6.

Step S6

If the gateway (P-GW) to be used is changed at step S4, the UE 102 is assigned with a new IP address. If the gateway (P-GW) is not changed, the UE 102 continuously uses the same IP address. The gateway (P-GW) has a function to assign the IP address, for example.

Step S7

The UE 102 changes the IP address of the UE 102 to the IP address assigned at step S6. In order to assign different IP address to the terminal (e.g., UE 102), the GTP tunnel may be configured between the radio base station 202 and the UE 102, as needed.

Step S8

In a case that the gateway 31 is selected, for example, transmission and reception of the IP packet between the UE 102 and the application server 401 is initiated through the gateway 31.

Note that messaging transmission and reception may include messaging responsive to an instruction. For example, if the route determination apparatus 20 receives at step S2 the application ID and the radio base station ID from the UE 102, the device 20 may return, to the UE 102, an Ack (Acknowledgement) to the UE 102, for example, a message indicating that the processing based on the received information is completed.

In the description above, assuming a case of uploading the data of the UE 102 to the application server 401 to perform processing of the data, the content is not needed to be taken into account. In contrast to this, in a case of dealing with the content, a table of the correspondence relationship to be used may be Table 2 or Table 3, rather than Table 1, in which a correspondence relationship includes the content ID instead of the application ID.

In Table 2, the content ID is used instead of the application ID in Table 1. In a case that the content ID common to the applications is used, i.e., a common content ID space is used, the application ID is not needed to be taken into account.

TABLE 2

| ID OF | | |
|---|---|---|
| CONTENT | ID OF RADIO BASE | ID OF GATEWAY |
| USED BY UE | STATION USED BY UE | (P-GW) |
| CONTENT 601 | RADIO BASE STATION 201 | GATEWAY 31 |
| | RADIO BASE STATION 202 | GATEWAY 31 |
| CONTENT 602 | RADIO BASE STATION 201 | GATEWAY 31 |
| | RADIO BASE STATION 202 | GATEWAY 32 |

If a UE using a certain content ID communicates with a radio base station, which gateway (P-GW) is optimally used can be determined by use of the correspondence relationship in Table 2. Selecting the gateway (P-GW) can be made by a method similar to that using Table 1 by replacing the application ID with the content ID in the description of the method using Table 1. Transferring the content ID can be achieved by including the ID in the IP packet.

Table 3 is a table representing a correspondence relationship for selecting the gateway (P-GW) to be passed through in a case that the content ID space is different for each application. If a prescribed content is downloaded during using a prescribed application, a server holding the content may be selected from the application servers to select a gateway (P-GW) through which (t1+t2) is minimum. A method for determining the gateway (P-GW) is similar to the method used in describing Table 1.

TABLE 3

| ID OF APPLICATION | ID OF CONTENT | ID OF RADIO BASE STATION | ID OF GATEWAY |
|---|---|---|---|
| USED BY UE | USED BY UE | USED BY UE | (P-GW) |
| APPLICATION 501 | CONTENT 601 | RADIO BASE STATION 201 | GATEWAY 31 |
| | CONTENT 602 | RADIO BASE STATION 202 | GATEWAY 31 |
| APPLICATION 502 | CONTENT 603 | RADIO BASE STATION 201 | GATEWAY 31 |
| | CONTENT 604 | RADIO BASE STATION 202 | GATEWAY 32 |

Note that in a case that an application, content and the like to be mainly used are determined in advance with respect to a user terminal, a user identifier and the like, if an ID of the user terminal, an ID of the user and the like are determined, an application, content and the like with respect to these IDs are determined. In this case, the user terminal ID, the user ID and the like may be used instead of the application ID, the content ID and the like.

In a case that users constitute a group and there is an application available to only the group, whether or not a user belongs to the user group may be determined by referring to user identifier instated of the application ID.

It is not necessary to create in advance a correspondence table (e.g., Table 1, Table 2, Table 3) for uniquely selecting the gateway (P-GW) with respect to the combination of the application ID, the content ID, and the radio base station ID.

For example, as indicated in Table 4, a metric (t1) between the radio base station and the P-GW and a metric (t2) between the P-GW and the application server are held for a certain application, and when the gateway (P-GW) is requested to be selected, (t1+t2) may be calculated to select the gateway (P-GW) through which (t1+t2) is minimum.

TABLE 4

| ID OF | | METRIC (t1) BETWEEN | METRIC (t2) BETWEEN |
|---|---|---|---|
| APPLICATION | ID OF RADIO BASE STATION | RADIO BASE STATION | GATEWAY MEANS (P-GW) AND |
| USED BY UE | USED BY UE | AND GATEWAY (P-GW) | APPLICATION SERVER |
| APPLICATION 501 | RADIO BASE STATION 201 | WHEN P-GW IS c: 10 | WHEN P-GW IS c: 30 |
| | | WHEN P-GW IS d: 20 | WHEN P-GW IS d: 10 |
| | RADIO BASE STATION 202 | WHEN P-GW IS 31: 10 | WHEN P-GW IS 31: 30 |
| | | WHEN P-GW IS 32: 20 | WHEN P-GW IS 32: 10 |

The P-GW is used as the gateway, but other gateway may be a selection target so long as it is a gateway existing between the UE and the application server, such as a serving gateway (S-GW). Selecting the S-GW may be made by adding the S-GW giving the shorted route as an item corresponding to the application ID and the radio base station ID, in addition to the P-GW, in Table 1 to Table 4, for example.

### (2) Second Example

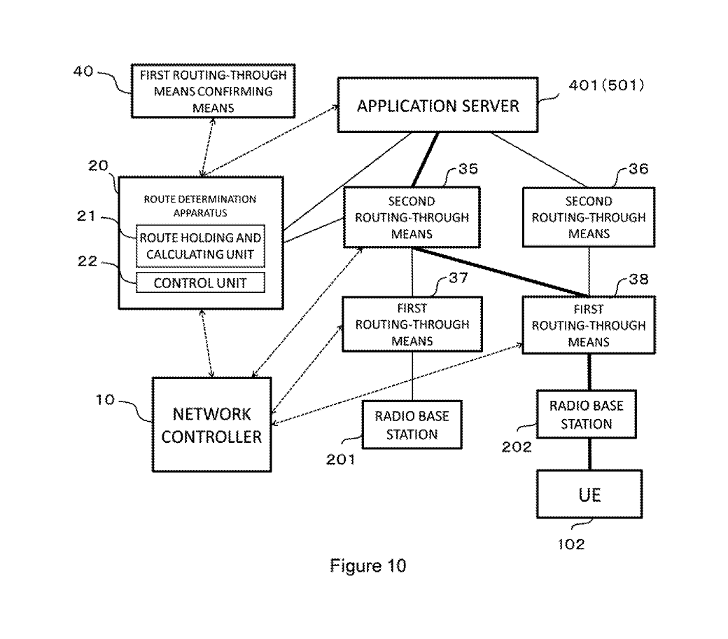

Next, a description is given of a second example with reference to FIG. 10. In a system configuration illustrated in FIG. 10, there can be used, as second routing-through means 35 and 36, the packet data network gateway (P-GW) described in reference literatures 1 and 2 above, for example. As first routing-through means 37 and 38, the serving gateway (S-GW) can be used. As first routing-through means confirming means 40, concretely, a home subscriber server (HSS) described in reference literatures 1 and 2 above can be used. As the network controller 10, the MME can be used. The MME usually acquires, from the UE, an international mobile subscriber identity (IMSI, see reference literatures 1 and 2 above) for authenticating the UE. The IMSI is possibly considered as a user identifier from its name. However, actually, the IMSI is assigned to a subscriber identity module (SIM) card. Since the SIM card is integrated in the terminal on a one-to-one basis, the IMSI can be considered as a user terminal identifier.

Other functional means illustrated in FIG. 10 may be similar to those described in the first example. Note that in order for the UE 102 to communicate with the application server 401 in the mobile network, it is necessary for the communication between the UE and server to passes through the radio base station, the first routing-through means, and the second routing-through means. The route through the base station and routing-through means is in order of the UE 102, the first routing-through means, the second routing-through means, and the application server in this or its inverse order.

In the first example described above, the gateway (P-GW) is selected for the combination of the ID of the application and the ID of the radio base station used by the UE. On the other hand, in the second example, as the positional information of the UE, an ID of an S-GW is used. The S-GW usually has an area allocated to itself, and is connected with a radio base station in the area. Therefore, once the radio base station used by the UE is determined, the S-GW to be used is determined. Further, the S-GW is a gateway located in a middle between the radio base station and the P-GW, and thus, is necessarily passed through by the communication traffic. Accordingly, specifying the radio base station and specifying S-GW are different, in terms of the route, only in which end of a route from UE 102 to S-GW is determined. To be more specific, if at least any one of the radio base station and the S-GW is determined, the route from the radio base station to the S-GW is settled, and therefore, even if either is selected, it is deemed that the same condition is selected in terms of the route. On the other hand, since the S-GW is associated with the UE 102 ID, values given to the route determination apparatus 20 may be the application ID and the radio user terminal identifier. Concretely, instead of obtaining the metric between the radio base station and the P-GW and the metric between the P-GW and the application server as in the first example described above, in the second example, the metric between the S-GW and the P-GW and the metric between the P-GW and the application server may be obtained.

The route holding and calculating unit 21 holds a correspondence relationship as indicated in Table 5 in advance. The correspondence relationship in Table 5 indicates the second routing-through means in terms of less delay. For example, indicated is that in the case that the UE is using the application 501, the delay between the UE and the application server is the smallest by using the second routing-through means 35 (P-GW) even when the UE 102 uses any of the first routing-through means 37 and 38 (S-GW).

TABLE 5

| ID OF | ID OF FIRST ROUTING- | ID OF SECOND |
|---|---|---|
| APPLICATION | THROUGH MEANS | ROUTING-THROUGH |
| USED BY UE | (S-GW) USED BY UE | MEANS (P-GW) |
| APPLICATION | FIRST ROUTING- | SECOND ROUTING- |
| 501 | THROUGH MEANS 37 | THROUGH MEANS 35 |
| | FIRST ROUTING- | SECOND ROUTING- |
| | THROUGH MEANS 38 | THROUGH MEANS 35 |
| APPLICATION | FIRST ROUTING- | SECOND ROUTING- |
| 502 | THROUGH MEANS 37 | THROUGH MEANS 35 |
| | FIRST ROUTING- | SECOND ROUTING- |
| | THROUGH MEANS 38 | THROUGH MEANS 36 |

A description is given of an operation according to the second example with reference to FIG. 10. As for the application 501 for the UE 102, the communication traffic toward the application server 401 first is routed through the first routing-through means (S-GW) and the second routing-through means (P-GW) and reaches the application server 401 in accordance with a procedure in a normal mobile network. Here, the communication traffic of the radio base station 202 is handled by the first routing-through means 38 (S-GW). If the UE 102 is in the cover area of the radio base station 202, the communication traffic from the radio base station 202 is routed through the first routing-through means 38 (S-GW). Assume that as for transfer times between the first routing-through means 38 (S-GW) and the second routing-through means 35 and 36 (P-GW), a transfer time with the second routing-through means 36 (P-GW) being selected is shorter. Therefore, first assume that the first routing-through means 38 (S-GW) is connected with the second routing-through means 36 (P-GW).

Next, the application server 401 recognizes an identifier and IMSI of the user terminal 102 from the reached communication traffic, and transmits the recognized IMSI of the user terminal 102 and an application ID to the route determination apparatus 20. In the route determination apparatus 20, the control unit 22 receives the information from the application server 401, and first transmits the IMSI to the first routing-through means confirming means 40 (HSS) to confirm the first routing-through means (S-GW) being used by the UE 102. Subsequently, the control unit 22 refers to the correspondence relationship in Table 5 held by the route holding and calculating unit 21 to select the second routing-through means (P-GW) corresponding to the combination of an ID of the confirmed S-GW and the application ID. For example, if the application used by the UE is the application 501 and the first routing-through means S-GW used by the UE 102 is the first routing-through means 38, it can be seen that the second routing-through means 35 is optimal as the second routing-through means. Therefore, the route determination apparatus 20 selects the second routing-through means 35, and notifies the network controller 10 of the selected information. With these operation, the network controller 10 configures a GTP tunnel between the first routing-through means 38 and the second routing-through means 35 such that the second routing-through means 35 is used as the second routing-through means, and performs control such that the communication traffic between the UE 102 and the application server 401 passes through the second routing-through means 35. Using such a scheme allows the second routing-through means 35 through which a delay is the smallest to be selected.

In the second example, the second routing-through means may be a virtual machine. In this case, a physical server having a hypervisor installed therein as the second routing-through means is specified. Then, a control message for generating the virtual machine may be transmitted by the route determination apparatus 20 to the specified physical server.

### (3) Third Example

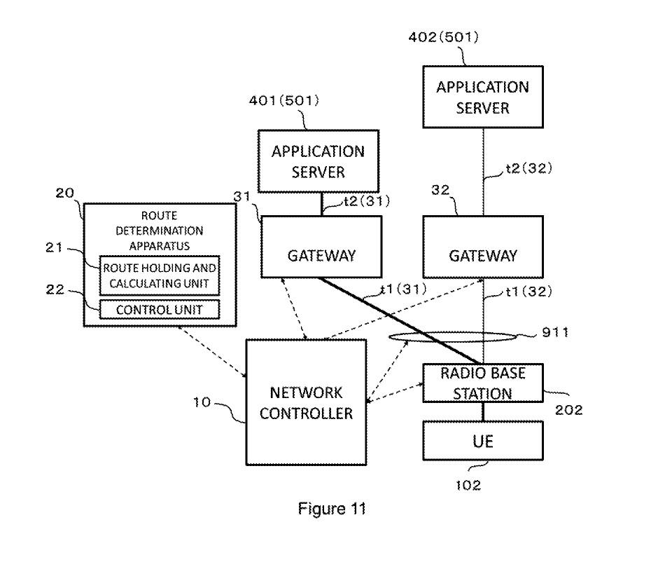

Next, a description is given of an implementation example in a case that the application servers are distributively provided as a third example with reference to FIG. 11.

As illustrated in FIG. 11, assume that the application 501 is distributively provided to multiple application servers 401 and 402. Here, assume that any of the application server 401 and 402 may be used to perform similar processing. In FIG. 11, assume that the application server 402 for the application 501 is an application server with the smallest delay from the gateway 32 (P-GW). Assume that a transfer time of the IP packet between the gateway 32 (P-GW) and the application server 402 is t2(32). Assume that the application server 401 for the application 501 is an application server with the smallest delay from the gateway 31 (P-GW). Assume that a transfer time of the IP packet between the gateway 31 (P-GW) and the application server 401 is t2(31). Other functional means illustrated in FIG. 11 may be similar to those described in the first example.

In the case of routing through gateway 31(P-GW), a required time between the radio base station 202 and the application server is t1(31)+t2(31). In the case of routing through gateway 32(P-GW), a required time between the radio base station 202 and the application server is t1(32)+t2(32).

Here, assume that an inequality sign is satisfied for (Formula 5) below.

t1(31)+t2(31)<t2(32)+t2(32) (Formula 5)

In the case that above (Formula 5) is satisfied, the delay is smaller when the gateway 31(P-GW) is selected as the gateway (P-GW). To be more specific, if the UE 102 using the application 501 is in the cover area of the radio base station 202, the route determination apparatus 20 may selects the gateway 31 (P-GW) as the gateway (P-GW).

The route holding and calculating unit 21 maintains a correspondence relationship as indicated in Table 6 below, for example.

TABLE 6

| ID OF | | |
|---|---|---|
| APPLICATION | ID OF RADIO BASE STATION | GATEWAY |
| USED BY UE | USED BY UE | (P-GW) ID |
| APPLICATION 501 | RADIO BASE STATION 202 | GATEWAY 31 |

Note that if a reverse inequality sign is satisfied for Formula 5, the gateway 32 may be held as the ID of the corresponding gateway (the ID of the P-GW) in Table 6.

In the case of the configuration as in FIG. 11, there may be a case that the application server 401 is selected and a case that application server 402 is selected, as the optimal selection of the application server due to the UE 102 moving. For example, a case of using other radio base station than the radio base stations 201 and 202, for example, a case of using a radio base station having an ID of 203, is a case that the gateway 32 (P-GW) is selected. In this case, the gateway (P-GW) is defined as indicated in Table 7 for the combination of the application ID and the radio base station ID.

TABLE 7

| ID OF APPLICATION | ID OF RADIO BASE | GATEWAY |
|---|---|---|
| USED BY UE | STATION USED BY UE | (P-GW) ID |
| APPLICATION 501 | RADIO BASE STATION 202 | GATEWAY 31 |
| APPLICATION 501 | RADIO BASE STATION 203 | GATEWAY 32 |

The destination IP address of the IP packet including the information of the application 501 output from the UE 102 needs to be the IP address of the application server 401 if the gateway 31 (P-GW) is selected, and be the IP address of the application server 402 if the gateway 32 (P-GW) is selected. In a case that both servers are assigned with IP addresses different from each other, an IP address of the destination server for the UE 102 is changed depending on circumstances. In order to solve this, a scheme of IP anycast is used. Multiple application servers (elements) are grouped, to which group the IP address is assigned as an anycast address. If the application servers 401 and 402 are assigned with the same anycast address, a router, switch, gateway and the like forwarding the IP packet perform forwarding to the nearest element as the application server. For this reason, if the UE 102 specifies the destination IP address (anycast address) of the server for the application 501, the UE 102 can use the application server 401 in the case of selecting the gateway 31 (P-GW) and use the application server 402 in the case of selecting the gateway 32 (P-GW).

As for the IP anycast, reference literature 9 below can be referred.

### REFERENCE LITERATURE 9

IETF (Internet engineering task force) RFC-1546
Reference literature 9 was disclosed at the following URL as of January 2015.
https://tools.ietf.org/html/rfc1546

Further, a correspondence relationship to which the IP address of the application server is added as indicated in Table 8 may be used without using the IP anycast, for example.

TABLE 8

| ID OF | ID OF RADIO | | IP ADDRESS OF |
|---|---|---|---|
| APPLICATION | BASE STATION | GATEWAY | APPLICATION |
| USED BY UE | USED BY UE | (P-GW) ID | SERVER |
| APPLICATION | RADIO BASE | GATEWAY 31 | IP ADDRESS OF |
| 501 | STATION 202 | | APPLICATION |
| | | | SERVER |
| | | | 401 |
| APPLICATION | RADIO BASE | GATEWAY 32 | IP ADDRESS OF |
| 501 | STATION 203 | | APPLICATION |
| | | | SERVER 402 |

In this case, regarding the gateway (P-GW), the gateway 31 (P-GW) is associated with the IP address of the application server 401, and the gateway 32 (P-GW) is associated with the IP address of the application server 402, for example. In the case of using this method, the destination IP address of the IP packet needs to be rewritten to the IP address of the associated application server. For this reason, the UE 102 changes the destination IP address of the IP packet created for the application 501 into the IP address of the application server described in Table 8. Note that the route determination apparatus 20 or the network controller 10 may instruct the radio base station 202 to rewrite the destination IP address, for example.

In the third example, a name of the server may be used for identifying the application server. In this case, a domain name system (DNS) server can be used for name resolution.

If the application servers are distributively provided as in the third example, particularly, if these servers are realized by the virtual machines, the IP address of the application server is possibly frequently added or changed. Then, when the combination of the identifier and the IP address (positional information) of the application server is changed or added, this change or addition may be notified to the route determination apparatus 20.

### (4) Fourth Example

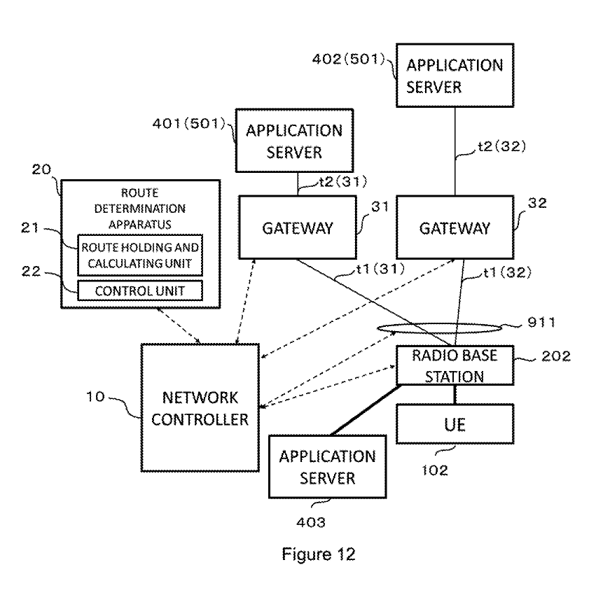

As description is given of an implementation example in a case that the application servers are locally distributed and provided, with reference to FIG. 12 and the like as a fourth example.

As illustrated in FIG. 12, assume that the application server 403 for the local application 501 is connected in the cover area of the radio base station 202. In this case, the gateway (P-GW) can be appropriately selected by making the IP address of the local application server with each other as indicated in Table 9. The application server 403 does not configure the tunnel to the gateway (P-GW), and thus, a field of the gateway (P-GW) is null.

TABLE 9

| | ID OF RADIO | | |
|---|---|---|---|
| ID OF APPLICATION | BASE STATION | GATEWAY | IP ADDRESS OF |
| USED BY UE | USED BY UE | (P-GW) ID | APPLICATION SERVER |
| APPLICATION 501 | RADIO BASE | GATEWAY 31 | IP ADDRESS OF |
| | STATION 201 | | APPLICATION SERVER 401 |
| | | | (GLOBAL ADDRESS) |
| APPLICATION 501 | RADIO BASE | NULL | IP ADDRESS OF |
| | STATION 202 | | APPLICATION SERVER 403 |
| | | | (LOCAL ADDRESS) |
| APPLICATION 501 | RADIO BASE | GATEWAY 32 | IP ADDRESS OF |
| | STATION 203 | | APPLICATION SERVER 402 |
| | | | (GLOBAL ADDRESS) |

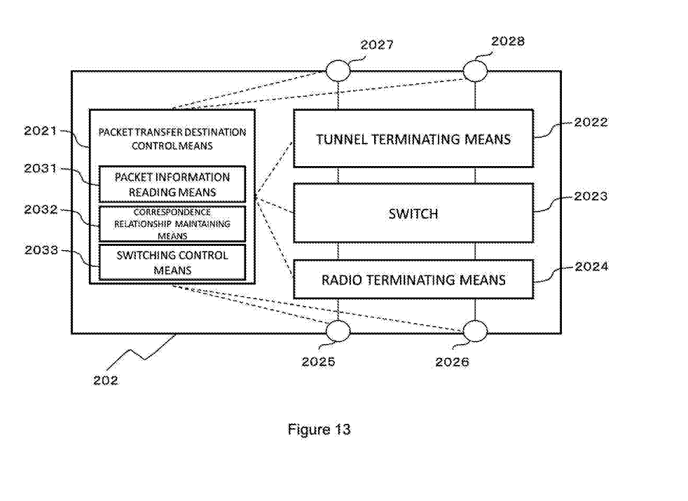

Next, a description is given of a configuration of the radio base station 202 according to the fourth example with reference to FIG. 13. The radio base station 202 includes a packet transfer destination control means 2021, a tunnel terminating means 2022, a switch 2023, a radio terminating means 2024, and interfaces 2025, 2026, 2027, and 2028.

The interfaces 2025, 2026, 2027, and 2028 perform connection and switching between any input/output interfaces in the radio base station 202 by a switching function of the switch 2023. The switch 2023 is switched under control by a switching control means 2033 in the packet transfer destination control means 2021. The interfaces 2025 and 2026 are interfaces on a local side and an access side, respectively. The interfaces 2027 and 2028 are interfaces on a core network side where the P-GW, the S-GW and the like are located. The radio terminating means 2024 also includes a control function such as channel assignment for the radio signal defined in 3GPP, and performs conversion into the radio signal used in an access network. The tunnel terminating means 2022 has a function to convert the signal for connecting to the core network side, such as a function to terminate the GTP tunnel. The packet transfer destination control means 2021 is means for determining the transfer destination or forwarding destination of the IP packet, and includes a correspondence relationship holding means 2032 including the correspondence relationship in Table 9. As the correspondence relationship holding means 2032, a database may be used. The packet transfer destination control means 2021 (packet information reading means 2031) monitors content (particularly, a header) of the IP packet reaching each of the radio terminating means 2024 and the tunnel terminating means 2022. The packet transfer destination control means 2021 controls to switch the switch 2023 depending on the monitored packet content. For example, the packet transfer destination control means 2021 refers to Table 9 to see the content of the input IP packet, and in a case of the IP packet for the application 501, the control means 2021 forwards the IP packet to the interface 2025 to connect to the local application server 403 without transferring to the interfaces 2027 and 2028 on the core network side. The monitored packet content may be at least any one of the application identifier, the content identifier, the originating IP address, and the destination IP address.

Next, a description is given of a concrete example of the operation. First, the radio signal including the IP packet for application 501 from the UE 102 is input to the interface 2026. The radio signal input from the interface 2026 is converted into an electrical signal by the radio terminating means 2024. After that, the packet transfer destination control means 2021 refers to the correspondence relationship in Table 9 therein to switch the switch 2023 to make transmission toward the local application server 403, i.e., to the interface 2025, not forwarding to the gateway (P-GW). In this way, if the application server 403 is located in local, the most optimal application server can be selected from among those including the application server located in local.

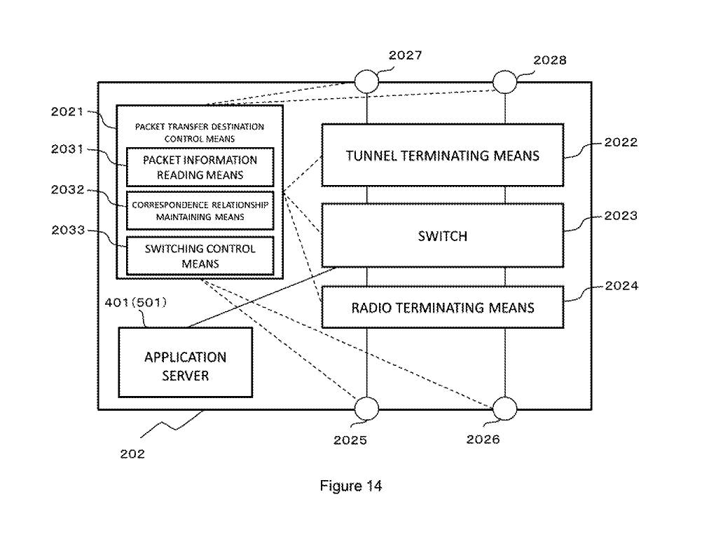

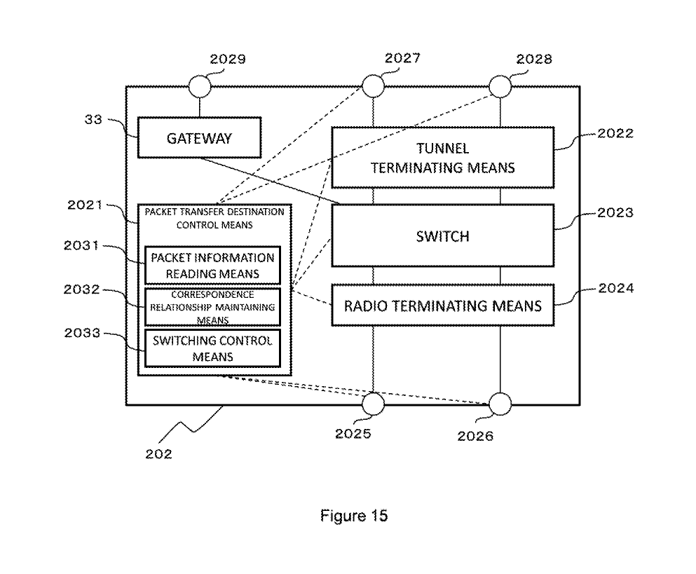

In the configuration of the radio base station 202 illustrated in FIG. 13, the application server for the application 501 is outside the radio base station 202 and is connected with the interface 2025. In a modification example, a configuration may be used in which the application server 403 for the application 501 is included within the radio base station 202 as illustrated in FIG. 14, for example. In this case, the packet transfer destination control means 2021 may hold the correspondence relationship in Table 9 similar to the configuration in FIG. 13. In another modification example, a configuration may be used in which the gateway 33 is included within the radio base station 202 as illustrated in FIG. 15. In FIG. 15, the gateway 33 capable of connecting with the outside via the interface 2029 can achieve a function as the packet data network gateway (P-GW) defined in 3GPP. In this case, the packet transfer destination control means 2021 holds a correspondence relationship between the gateway (P-GW) ID and the application server IP address for the application ID and the radio base station ID, as indicated in Table 10, for example.

TABLE 10

| ID OF | ID OF RADIO | | IP ADDRESS OF |
|---|---|---|---|
| APPLICATION | BASE STATION | GATEWAY | APPLICATION |
| USED BY UE | USED BY UE | (P-GW) ID | SERVER |
| APPLICATION | RADIO BASE | GATEWAY 33 | IP ADDRESS OF |
| 501 | STATION 202 | | APPLICATION |
| | | | SERVER 403 |
| APPLICATION | RADIO BASE | GATEWAY 32 | IP ADDRESS OF |
| 502 | STATION 202 | | APPLICATION |
| | | | SERVER 402 |

Assume that the radio base station 202 is connected to the application server 403 for the application 501 through the gateway 33. Assume that the application server 403 is a server for the application 501 nearest the radio base station 202. Next, a description is given of a concrete example of operation. First, when the IP packet for the application 501 reaches the radio base station 202, the IP packet is transferred toward the gateway 33 (local gateway) held by the radio base station 202. Such a configuration allows the IP packet to be transferred to the application server 403 smaller in delay in the network connected with the local gateway. In other words, the UE 102 can use the application server 403 shorter in the transfer time from the UE 102.

In the fourth example, a configuration may be used in which the application server is connected with the gateway 31 or another gateway (S-GW or the like) between the radio base station 202 and the gateway 31. In this case, a configuration may be used in which the switch 2023 and the packet transfer destination control means 2021 controlling the switch 2023 as illustrated in FIG. 13 are included between a local network side interface and a core network side interface of the gateway.

### (5) Fifth Example

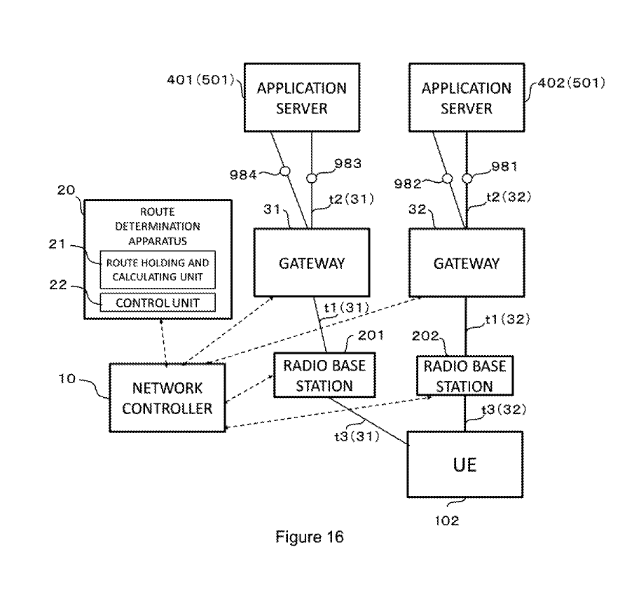

Next, a description is given of a fifth example with reference to FIG. 16.

In the first to fourth examples, it is assumed that a single access point name (APN) is used as the APN. For this reason, the correspondence relationship regarding the APN is not given. On the other hand, if multiple APNs are used, the network candidates to be connected are further increased, and thus, the P-GW which is further optimal, in other words, smaller in delay is possibly selected. Therefore, the fifth example describes an implementation example of the example in the case of using multiple APNs.

In general, multiple APNs are possibly selected for a certain P-GW. For this reason, in the fifth example, the ID of the P-GW corresponding to the application ID and radio base station ID is further associated with the APN. This allows an optimal P-GW and APN to be selected for an application used by a UE in a cover area of a certain radio base station. Therefore, in the fifth example, the route holding and calculating unit 21 holds a correspondence relationship as indicated in Table 11.

TABLE 11

| ID OF | ID OF RADIO | | |
|---|---|---|---|
| APPLICATION | BASE STATION | GATEWAY | |
| USED BY UE | USED BY UE | (P-GW) ID | APN ID |
| APPLICATION 501 | RADIO BASE | GATEWAY 32 | APM 981 |
| | STATION 202 | | |
| APPLICATION 501 | RADIO BASE | GATEWAY 31 | APM 983 |
| | STATION 201 | | |

APNs 981 and 982 are connected to the gateway 32 (P-GW), and APNs 983 and 984 are connected to the gateway 31 (P-GW), as illustrated in FIG. 16. The route determination apparatus 20 may use Table 11 in order to freely select the APN that the UE can use. Concretely, since the APN which the UE can use is limited, a list of available APNs is given to the route determination apparatus 20. Then, Table 11 may be made with limitation to the available APNs.

### (6) Sixth Example

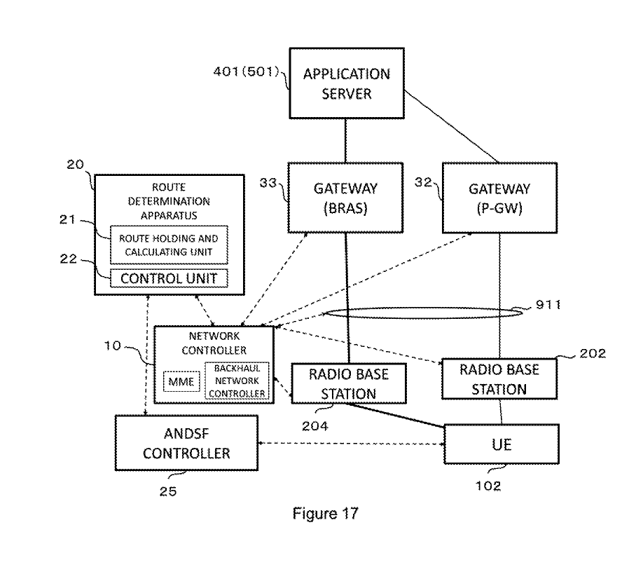

The first to fifth examples assume that the radio base station defined in 3GPP is used in the selection of the radio base station for an access system. On the other hand, in a sixth example, a description is given of an implementation example of the example in which the radio base station is also selected as an optimal one in addition to selecting the gateway in an environment capable of selecting multiple radio base stations. A description is given using FIG. 17 as the sixth example.

Concretely, the route determination apparatus 20 (route holding and calculating unit 21) may hold a correspondence relationship in which the optimal gateway and radio base station are associated with the application being used by the UE and the positional information of the UE, as indicated in Table 12.

TABLE 12

| ID OF | POSITIONAL | | |
|---|---|---|---|
| APPLICATION | INFORMATION | RADIO BASE | |
| USED BY UE | OF UE | STATION ID | GATEWAY ID |
| APPLICATION 501 | POSITION 701 | RADIO BASE | GATEWAY 32 |
| | | STATION 202 | |
| APPLICATION 501 | POSITION 702 | RADIO BASE | GATEWAY 33 |
| | | STATION 204 | |

As the positional information of the UE, a latitude and longitude from the global positioning system (GPS) can be used. Alternatively, the cover area of the radio base station in which the UE is located can be founded by transmitting the ID of the radio base station from which the UE is performing reception to the route determination apparatus 20. To be more specific, since a rough position of the UE is found, the ID of the radio base station being used by the UE can be used also as the positional information. The position of the UE can be also identified by transmitting the IDs of all the radio base stations from which the UE can receive to the route determination apparatus 20. The strict positional information is not necessarily used, and, for example, the UE may be mapped to a space in which the positions of the radio base station and gateway are abstracted and may use the mapped coordinates as the positional information of the UE.

In this case, the route determination apparatus 20 may notify the network controller 10 of the ID of the optimal gateway and the radio base station ID such that the network controller 10 configures a link or tunnel connecting the radio base station and the gateway.

As an example of means for making the UE select the optimal radio base station, a scheme of an access network discovery and selection function (ANDSF) defined in 3GPP may be used. The UE may be made to select the radio base station selected by the route determination apparatus 20.

As for the ANDSF, reference literature 10 below can be referred.

### REFERENCE LITERATURE 10

TS 23.402 “Architecture enhancements for non-3GPP access”
Reference literature 10 was disclosed at the following URL as of January 2015.
http://www.qtc.jp/3GPP/Specs/23402-a70.pdf

The radio base station switched by use of the ANDSF includes the radio base station which terminates the radio signal in accordance with the Institute of Electric and Electronics Engineers (IEEE) 802.11 series (wireless LAN) defined in the IEEE. In this case, if the radio base station is connected to the mobile network, the gateway is the P-GW, but if the radio base station is connected to a fixed access line, the gateway is a BRAS.

As for the broadband remote access server (BRAS), reference literature 11 below can be referred.

### REFERENCE LITERATURE 11

Technical Report, DSL Forum (Broadband Forum, presently)
TR-092 “Broadband Remote Access Server (BRAS) Requirements Document”
Reference literature 11 was disclosed at the following URL as of January 2015.
https://www.broadband-forum.org/technical/download/TR-092.pdf

A description is given of a configuration and operation according to the sixth example in the case of using the ANDSF with reference to FIG. 17. In FIG. 17, an ANDSF controller 25 is connected to each of the route determination apparatus 20 and the UE 102. A radio base station 204 is a base station of the wireless LAN. As for the operation, first, the application being used by the UE 102 and positional information are input to the route determination apparatus 20. Subsequently, the route determination apparatus 20 refers to the correspondence relationship in Table 12 held by the route holding and calculating unit 21 to select the ID of the optimal gateway means and the ID of the optimal radio base station. Then, a connection policy that connection is made to the selected radio base station is notified to the ANDSF controller 25. For example, if the positional information of the UE 102 using the application 501 is “702”, the optimal radio base station is the radio base station 204 and the optimal gateway is the gateway 33 as is seen from the relationship in Table 12. The route determination apparatus 20 notifies the ANDSF controller 25 of that the UE 102 uses the radio base station 204 connected with the gateway 33. The ANDSF controller 25 uses a method as described in reference literature 10 above to connect the UE 102 to the radio base station 204. As for the process for connecting the radio base station 204 to the gateway, the GTP is configured to configure a tunnel between the gateway and the radio base station. This allows the radio base station to be connected to the gateway determined by the route determination apparatus 20. Note that other than the GTP, an asynchronous transfer mode (ATM) or a point-to-point protocol (PPP) may be used to configure a link

### (7) Seventh Example

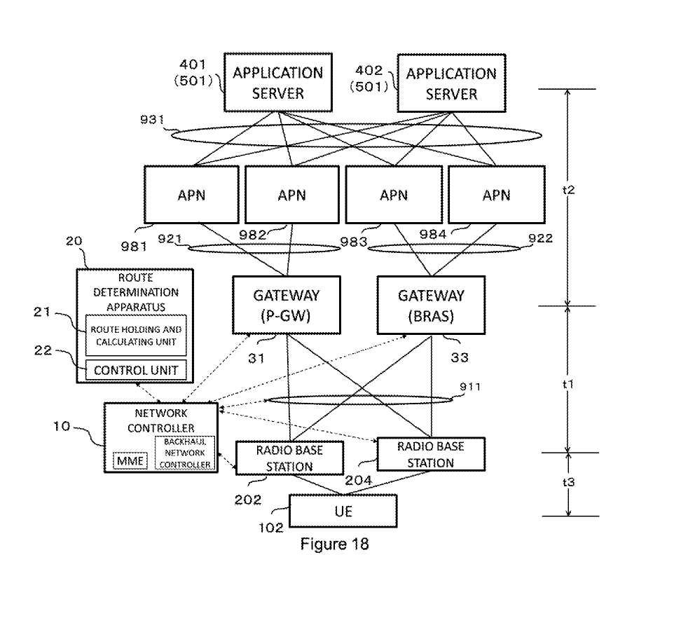

A description is given of an example as a seventh example in which the invention of determining the gateway from the application ID and the content ID is further extended with reference to FIG. 18.

First, assuming that a time required for information delivery between the radio base station and the gateway is t1, a time required for delivery between the gateway and the application server is t2, and a time required for delivery between the UE and the radio base station is t3, a delay between the UE and the application server is represented by t3+t1+t2 as illustrated in FIG. 18. Here, t2 depends on which APN is to be used. Therefore, the APN may also be a target selected by the route determination apparatus 20. However, this does not hold in an environment where the APN is initially determined to be a single, with no room for choice.

In general, if a position of a certain terminal is determined for a certain application, the gateway ID, the radio base station ID, the APN ID, and the application server ID may be selected such that a delay is the smallest. For this reason, a correspondence relationship as indicated in Table 13, for example, is created such that the optimal radio base station ID, gateway ID, APN ID, and application server ID are determined for the application ID and the positional information of the UE.

TABLE 13

| ID OF | POSITIONAL | | | | |
|---|---|---|---|---|---|
| APPLICATION | INFORMATION | ID OF RADIO BASE | | | ID OF |
| USED BY UE | OF UE | STATION | GATEWAY ID | APN ID | APPLICATION SERVER |
| APPLICATION 501 | POSITION 701 | RADIO BASE STATION | GATEWAY 31 | APN 981 | APPLICATION SERVER |
| | | 202 | (P-GW) | | 401 |
| | | (eNodeB) | | | |
| APPLICATION 501 | POSITION 702 | RADIO BASE STATION | c | APN 984 | APPLICATION SERVER |
| | | 204 | (BRAS) | (IDENTIFIER OF | 402 |
| | | (WiFi BASE STATION) | | INTERNET | |
| | | | | SERVICE | |
| | | | | PROVIDER) | |

As choices of the gateway, radio base station, APN, and application server, apparatuses or the like existing in the vicinity of above-exemplified apparatuses are considered as targets and t1+t2+t3 of each realistic combination of the apparatuses is calculated, and then, the combination having the smallest calculated value may be determined in advance. Here, as for the realistic combination, all the possible combinations of nodes are not calculated, but combinations from which the application servers in a remote location difficult to use in view of the position of the UE are excluded. For example, if the position of the UE is in Tokyo, an application server located in Brazil far away from the UE can be excluded.

As the radio base station, a 3G or LTE radio base station defined in 3GPP/3GPP2 or a radio base station (wireless LAN base station) terminating the radio signal defined in accordance with IEEE 802.11 series may be used. The gateway connected with the radio base station is the P-GW or a broadband remote access server (BRAS) in a fixed network. If the radio base station is a wireless LAN base station, the scheme of the ANDSF can be used to control change of the wireless LAN. For this reason, the change of the wireless LAN can trigger the route determination apparatus 20 to select the gateway and the like.

The ANDSF is defined in 3GPP as means for determining whether to select the eNodeB (see reference literatures 1 and 2) that is the LTE radio base station or a WiFi radio base station. Therefore, if the optimal gateway and radio base station are selected by the route determination apparatus 20, the ANDSF can be used for the processing to make the UE use the selected radio base station.

In the above-described example, the positional information is not limited to the latitude and longitude information by use of the GPS, but may be the radio base station ID superimposed on a beacon detected by the UE, for example.

The elements determined by the route determination apparatus 20 may not be all but a subset of those in Table 13. For example, if the fixed APN is used, the route determination apparatus 20 does not need to select the APN. In a system in which the cover areas of the radio base stations do not overlap each other, the radio base station is uniquely determined for the position, and thus, the route determination apparatus 20 does not need to determine the radio base station. In Table 13, only the P-GW is associated with the gateway, but the S-GW may be associated. If multiple S-GWs are included in candidates for one base station, the S-GWs may be made to be included in the correspondence relationship as indicated in Table 13 such that the route determination apparatus 20 can select the S-GW through which the route is less in delay to allow the route less in delay to be used.

### (8) Eighth Example

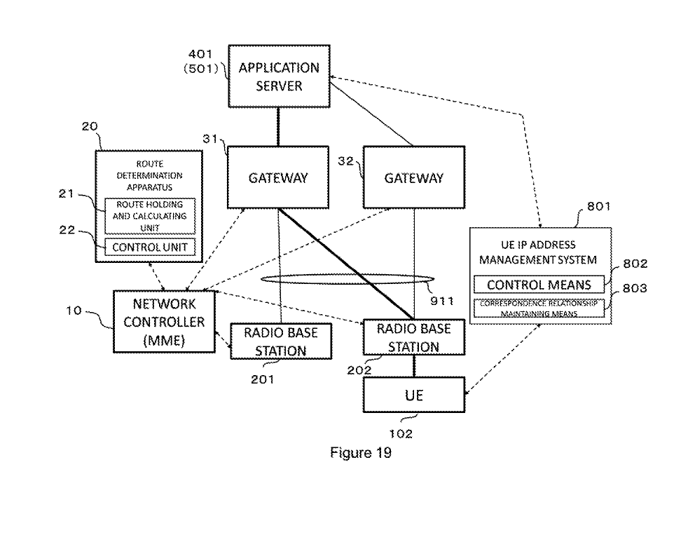

Next, a description is given of an eighth example regarding the IP address of the UE with reference to FIG. 19 and the like.

First, when the gateway (P-GW) assigning the IP address is changed, the IP address of the UE is also changed. This is because the gateway (P-GW) assigns the UE with the IP address of the network to which the gateway belongs. In a case that communication is initiated from the UE, the IP address of the UE is delivered to the application server and the application server can grasp the IP address of the UE, with no problem in terms of the operation of the application. On the other hand, in a case of push delivery that communication is initiated from the application server to the UE, the application server cannot grasp the IP address of the UE. In a case also that the IP address is changed during communication in the application, the similar problem is likely to occur. The eighth example can deal with such a problem according to a configuration as illustrated in FIG. 19.

FIG. 19 is a system in which a user terminal (UE) IP address management system 801 is added to the configuration illustrated in FIG. 4, for example. To be more specific, the UE IP address management system 801 includes a correspondence relationship holding means 803 for holding the correspondence relationship between the UE identifier or user identifier and the IP address as indicated in Table 14, Table 15 or the like, and a control means 802.

For example, the correspondence relationship holding means 803 holds a correspondence relationship between a subscriber identifier of the UE (international mobile subscriber identity: IMSI) and the IP address of the UE as indicated in Table 14. Or the correspondence relationship holding means 803 holds a relationship between a user identifier and IP address of the application as indicated in Table 15. The correspondence relationship holding means 803 may use a database, for example.

TABLE 14

| IMSI | IP ADDRESS |
|---|---|
| 012345678912345 | i |
| 012345678912346 | j |

TABLE 15

| USER ID | IP ADDRESS |
|---|---|
| TOM | i |
| ALICE | j |

For example, when the control means 802 receives from the application server 401 a message inquiring the IP address corresponding to the UE subscriber identifier or the application user identifier, the control means 802 refers to the correspondence relationship holding means 803 to search for the IP address corresponding to the identifier. If finding the corresponding IP address, the control means 802 returns the found address to the inquirer (e.g., the application server 401).

The IP address may be updated at a timing when an operating system (OS) installed in the UE recognizes the IP address change. Usually, the OS of the terminal (address change detection means) manages the IP address, and therefore, can detect the IP address change. If the UE detects that the IP address the UE uses is changed, the UE transmits the correspondence relationship between a terminal identifier of the UE or the user identifier and the IP address of the UE to the UE IP address management system 801. Then, the UE IP address management system 801 updates the information on the identifier and IP address corresponding to the identifier by the correspondence relationship holding means 803 in the UE IP address management system 801.

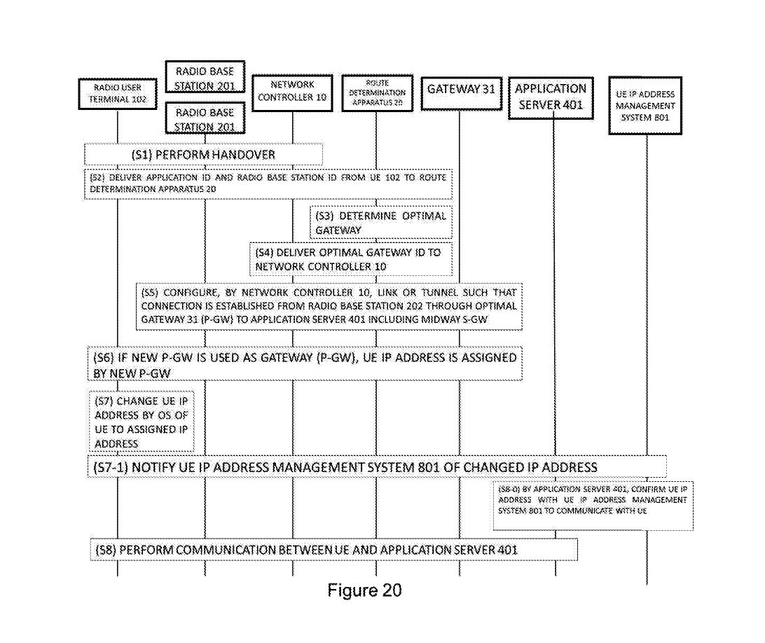

A description is given of processing for updating the IP address of the UE with reference to FIG. 20. In FIG. 20, step S7-1 and step S8 are added as compared to the processes described in FIG. 6. At step S7-1, the new IP address of the UE to be updated at step S7 is notified to the UE IP address management system 801. With this operation, the correspondence relationship between the IMSI or user ID and the IP address is registered or updated in Table 14 and Table 15. The UE may grasp in advance an IP address of the UE IP address management system 801 to transmit a message addressed to the IP address of the UE IP address management system 801.

Step S8 is a step to a communication starting process on the application server side. First, at step S8-0, the application server inquires of the UE IP address management system 801 to obtain the updated IP address of the UE, and uses the obtained IP address to perform push delivery to the UE. Here, if the UE uses the IP address different for each application, the UE IP address management system 801 may manage also the application identifier in addition to an identification number of the UE.

As another method for updating the IP address of the UE, when the route determination apparatus 20 determines to change the gateway, the determination may trigger to notify the UE IP address management system 801 of a fact of the gateway change. Subsequently, once the UE IP address management system 801 receives the notification, the UE IP address management system 801 can inquire of the UE 102 about the changed IP address to recognize the updated IP address.

Using the UE IP address management system 801 has an effect particularly on such a case as below. For example, in a case that the UE connects from the wireless LAN to a fixed carrier network, the UE is assigned with an IP address beyond mobile carrier management. For this reason, the mobile carrier has difficulty in grasping the IP address of the UE, but can find the IP address of the UE by inquiring of the UE IP address management system 801 even if the UE is connected to a different network provider.

The above description assumes the case where the main application used by the UE is determined and the optimal gateway for the determined application is used. In another example, the user identifier of an application and the UE identifier may be combined. Using the combination of the user identifier of an application and the UE identifier as the identifier allows the UE to be identified distinguishably from other terminals even if the user accesses from various terminals.

The UE identifier is not limited to the IMSI, and, for example, may be another identifier capable of uniquely identifying the UE such as a MAC address of the UE.

Next, there is a case that when a single UE operates multiple applications, the route determination apparatus 20 selects the optimal gateway for each application. In this case, the gateway to be used is different for each of the combinations of the IMSI and the application ID, and therefore, the IP address used by the UE is also different. In order for a single UE to use the IP address different for each application, first, multiple virtual machines are made to operate in the single UE. Then, each virtual machine operates different client software. To the respective virtual machines, IP addresses assigned differently. Alternatively, a single terminal uses multiple network interfaces. To be more specific, the IP packets are output via the network interfaces different for each application. Then, the UE IP address management system 801 may instruct its correspondence relationship holding means 803 to hold the IP address corresponding to the combination of the UE identifier (IMSI, here) and the application ID as indicated in Table 16.

TABLE 16

| IMSI | ID OF APPLICATION | IP ADDRESS |
|---|---|---|
| 012345678912345 | APPLICATION 501 | i |
| 012345678912345 | APPLICATION 502 | j |
| 012345678912346 | APPLICATION 503 | k |

### (9) Ninth Example

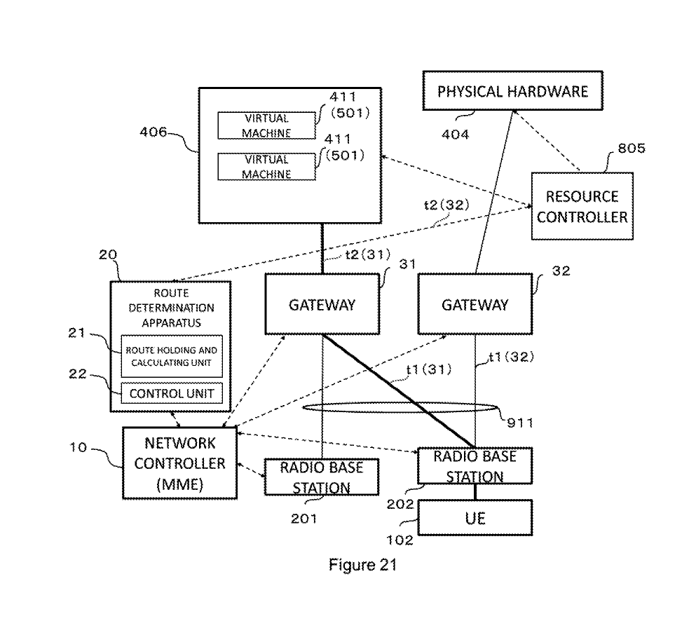

Next, a description is given of a ninth example in which a server, a network device and the like are remotely controlled to be created and used as needed, with reference to FIG. 21. In FIG. 21, a physical server 406 is a physical server as physical entity, and has a hypervisor installed therein. Examples of the hypervisor may include a kernel-based virtual machine (KVM) based on Linux (registered trademark). The physical server 406 can create multiple virtual machines in accordance with external commands. In other words, the physical server 406 can install the application server, a virtual base station and the like on the virtual machine. A resource controller 805 manages and controls resources of the physical server 406. For example, the resource controller 805 manages amounts of memory and CPU resources currently used by the physical server 406, left amounts of the memory and CPU resources and the like, and controls to create or delete the virtual machine in or from the physical server 406, or install an application in the virtual machine, and so on. The resource controller 805 may be cloud-based (cloud platform or Orchestrator) such as an OpenStack that is open source software. A physical hardware 404 is physical hardware, and can install the OS, the hypervisor and the like under the control of the resource controller 805. The application operating on the OS can be installed or uninstalled to and from the physical server 406 remotely by the resource controller 805. As an alternative method, the physical server 406 may install multiple applications in advance within an OS level to which remote installation is permitted, and thereafter, the resource controller 805 may control the physical server 406 to install or uninstall the application. Note that the resource controller 805 may be incorporated into the network controller 10.

As illustrated in FIG. 21, the physical server 406 capable of storing the virtual machine and the physical hardware 404 are distributively provided in advance. Then, when processing of an application is requested, the resource controller 805 performs processing to create a virtual machine at a place near the user in order to perform that requested processing, and install the application on the virtual machine. In order to achieve such processing, the route holding and calculating unit 21 included in the route determination apparatus 20 holds the IP address as indicated in Table 17 in advance for providing an application service corresponding to the combination of the application ID and the positional information. Concretely, the route holding and calculating unit 21 holds, as indicated in Table 17, a name or IP address of the physical server through which a delay is the smallest when an application is installed and operated in a virtual server which is newly created on the physical server 406. The route holding and calculating unit 21 also holds, as indicated in Table 17, a name or IP address of the gateway through which a delay is the smallest.

TABLE 17

| | | NAME OR IP ADDRESS OF OPTIMAL | |
|---|---|---|---|
| | | PHYSICAL SERVER AMONG | NAME OR IP ADDRESS |
| | | APPLICATION SERVER GROUP | OF OPTIMAL GATEWAY |
| ID OF | POSITIONAL | INCLUDING CASES IN WHICH VIRTUAL | IN CASE OF |
| APPLICATION | INFORMATION OF | SERVER IS GENERATED AND | GENERATING VIRTUAL |
| USED BY UE | UE | APPLICATION IS OPERATED | SERVER |
| APPLICATION 501 | POSITION 701 | APPLICATION SERVER 406 | GATEWAY 31 |
| APPLICATION 501 | POSITION 702 | APPLICATION SERVER 404 | GATEWAY 31 |
| APPLICATION 501 | POSITION 703 | APPLICATION SERVER 405 | GATEWAY 32 |

As for the operation, when the UE using the application 501 moves to a position 701, the UE 102 notifies the route determination apparatus 20 of the application ID and the positional information. The route determination apparatus 20 refers to the route holding and calculating unit 21 holding the correspondence relationship indicated in Table 17, and creates a virtual server on the physical server 406 to install and operate the application 501. Further, the route determination apparatus 20 grasps that selecting the gateway 31 as a gateway for an external network connection makes a delay between the UE 102 and the application 501 be the smallest. Therefore, the route determination apparatus 20 transmits to the resource controller 805 a command to create a virtual machine 411 in the physical server 406. The resource controller 805 sends the command to the physical server 406 to create the virtual machine 411. Next, the route determination apparatus 20 issues an instruction to the virtual machine 411 to install the application 501, and the application 501 is installed.

In another example, the gateway itself may be virtualized. In this case, as indicated in Table 18, a name or IP address (positional information k in the IP network) of the physical server virtually creating the gateway, and an IP address of the physical server through which a delay is the minimum in a gateway group may be made to correspond to the combination of the application used by the UE and the positional information of the UE.

TABLE 18

| | | | NAME OR IP ADDRESS OF OPTIMAL |
|---|---|---|---|
| | | NAME OR IP ADDRESS OF OPTIMAL PHYSICAL | PHYSICAL SERVER AMONG GATEWAY |
| ID OF | POSITIONAL | SERVER AMONG APPLICATION SERVER GROUP | GROUP INCLUDING CASES IN WHICH |
| APPLICATION | INFORMATION OF | INCLUDING CASES IN WHICH VIRTUAL SERVER IS | VIRTUAL SERVER IS GENERATED AND |
| USED BY UE | UE | GENERATED AND APPLICATION IS OPERATED | GETEVVAY IS OPERATED |
| APPLICATION 501 | POSITION 701 | APPLICATION SERVER 406 | GATEWAY 31 |
| APPLICATION 501 | POSITION 702 | APPLICATION SERVER 404 | GATEWAY 31 |
| APPLICATION 501 | POSITION 703 | APPLICATION SERVER 405 | GATEWAY 32 |

In other example, after the handover for the UE, the route determination apparatus 20 first selects the application server and gateway through which a delay is the smallest. In parallel with such selection, the route determination apparatus 20 selects the optimal application server and gateway also taking the virtualized configuration into consideration. Then, in a case that the delay is smaller if the virtualized configuration is selected, the route determination apparatus 20 selects the virtualized application server and the virtualized gateway. After the virtualized application server and virtualized gateway to be needed are created, the route determination apparatus 20 may switch the application server and the gateway such that the created virtualized application server and the virtualized gateway are used.

In a concrete operation, first, in a state where the configuration is not changed, the route determination apparatus 20 receives the ID of the application used by the UE and the positional information of the UE from the UE in order to find the optimal application server and gateway. Next, the route determination apparatus 20 refers to a correspondence relationship in Table 19 held by the route holding and calculating unit 21 to select the optimal application server and gateway. This processing may be made by performing the processing illustrated in FIG. 6 described above, for example.

After that, if the virtual machine is used, the route determination apparatus 20 changes the application server and gateway such that optimal server and gateway may be used. For example, the positional information of the UE 102 using the application 501 is 701 in accordance with the relationship in Table 19, the route determination apparatus 20 once selects the application server 401 as an application server and selects the gateway 31 (P-GW) as a gateway. At the same time as such selection, the route determination apparatus 20 configures a virtualized machine in a physical server i, and prepares an application server in the machine and prepares a virtual gateway in a physical server 1. After the preparation is completed, transition is made from the application server 401 to the application server created in the physical server i, and from the gateway 31 (P-GW) to the gateway created in the physical server 1. This processing allows the route determination apparatus 20 to select the application server 401 and gateway 31 which are available right away such that those are firstly to be used, achieving quick connection. After that, the route determination apparatus 20 make a transition to a configuration for using the optimal application server and gateway including the case of configuring the virtual machine and the virtual gateway. Such processing can achieve more efficient system which enables both connection to the external network without keeping the user waiting and optimality with less delay.

TABLE 19

| | | | | | NAME OR IP |
|---|---|---|---|---|---|
| | | | | | ADDRESS OF |
| | | | | | PHYSICAL |
| | | | | | SERVER |
| | | | | | ON WHICH |
| | | | | NAME OR IP ADDRESS | OMTIMAL |
| | | | | OF PHYSICAL SERVER | GATEWAY IS |
| | | | | ON WHICH OMTIMAL | CONFIGURABLE |
| | | | | VIRTUAL SERVER IS | IN CASE OF |
| | | | NAME OR IP | CONFIGURABLE IN | NEWLY |
| ID OF | POSITIONAL | NAME OR IP | ADDRESS OF | CASE OF NEWLY | GENERATING |
| APPLICATION | INFORMATION | ADDRESS OF OPTIMAL | OPTIMAL | GENERATING VIRTUAL | VIRTUAL |
| USED BY UE | OF UE | APPLICATION SERVER | GATEWAY | APPLICATION SERVER | GATEWAY |
| APPLCATION | POSITION 701 | APPLICATION SERVER 401 | GATEWAY 31 | i | l |
| 501 | | | | | |
| APPLICATION | POSITION 702 | APPLICATION SERVER 402 | GATEWAY 31 | NULL | m |
| 501 | | | | | |
| APPLICATION | POSITION 702 | APPLICATION SERVER 400 | GATEWAY 32 | k | n |
| 502 | | | | | |

As described above, by remotely, as needed, creating or deleting the server and the gateway, and installing and uninstalling the application, as the number of users increases, the application server and the gateway can be promptly added near a place of the user increasing. Particularly, there is an advantage that a delay can be set to be small following a change in a state of demand. At the same time, since the network at the shortest distance is used depending on a change in a user's demand state, the configuration can be changed so as to use minimum network resources depending on the user's demand state, allowing efficient management.

In the above description, a virtual configuration for the radio base station is not mentioned, but the radio base station may be virtually configured. The configuration of the radio base station can be divided into a hardware part handling the radio signals provided near an antenna for a radio communication part, a controlling part controlling the hardware part, and a part handling main signals obtained by converting radio main signals into electrical main signals. The latter part, i.e., the controlling part and the main signal handling part, corresponds to a part of information processing, and thus, can be realized by not a special hardware device but a general-purpose information processing server. The general-purpose information processing server can be realized by one server, or by using a cloud server, in which a virtual server is configured. Therefore, the seventh example in which the radio base station is determined using at least any one of the application identifier and the content identifier (e.g., the example by use of Table 13) may be combined with the ninth example to configure the information processing server for the radio base station as the virtual server.

For example, the packet transfer destination control means 2021 illustrated in FIG. 13 to FIG. 15 is a server which can be realized by software, and therefore, a part as the means 2021 may be realized by virtualization. On the other hand, as for the hardware-like configuration in the radio base station, by applying a VLAN to the switch 2023 illustrated in FIG. 13 to FIG. 15 controlled by the packet transfer destination control means 2021, the switch 2023 can be virtualized to be used. This is because a VLAN tag can be added to and removed from an input/output port of the switch 2023 to configure networks not interfering with each other on the same switch by use of the VLAN tag in the switch as an identifier.

### (10) Tenth Example

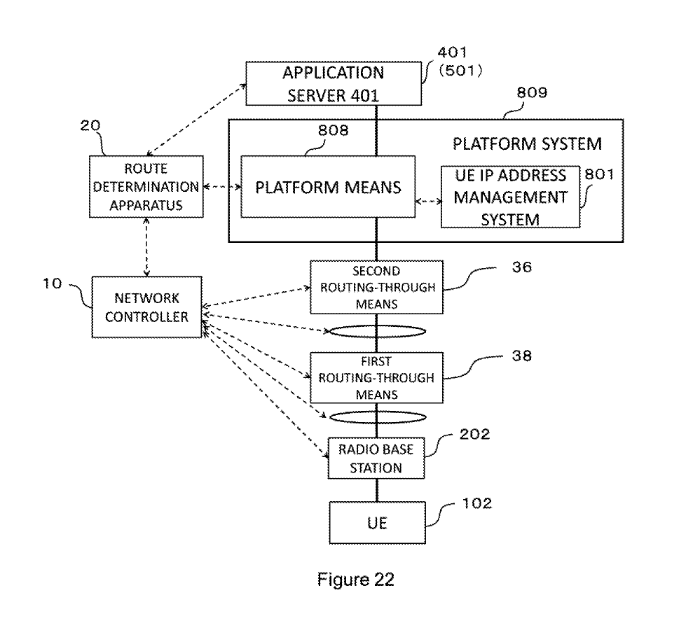

A description is given of a tenth example embodied as a platform of a mobile application service with reference to FIG. 22. As for the connection, the communication traffic from the UE 102 is connected through the radio base station 202, the first routing-through means 38, and the second routing-through means 36 to the application server 401 for the application 501, as described above examples. Further, in the tenth example, a platform system 809 is inserted between the second routing-through means 36 and the application server 401. In FIG. 22, the communication traffic from the UE 102 to the application server 401 for the application 501 and the communication traffic from the application server 401 to the UE 102 are necessarily routed through a platform means 808. The platform means 808 holds in advance information of the application server corresponding to the application ID. Therefore, a destination address of the IP packet of the application 501 sent from the UE 102 can be directed not to a destination of the application server 401 but to a destination of the platform means 808. A header or payload in the IP packet includes the application ID and the user terminal ID, as described in the first and other examples above, for example. The platform system 809 includes, besides the platform means 808, the UE IP address management system 801.

In an operation according to the tenth example, first, the communication traffic of the application 501 from the UE 102 reaches the platform means 808 through the radio base station 202, the first routing-through means 38, and the second routing-through means 36. The platform means 808 extracts the application ID and the positional information of the UE from the reached IP packet. The extracted information is passed to the route determination apparatus 20. This allows the optimal one as the second routing-through means 36 to be selected as described in the first to ninth examples above, for example. When the selected second routing-through means 36 is notified to the network controller 10, the network controller 10 sets up the second routing-through means 36, the first routing-through means 38, and the radio base station 202 for a tunnel such that the communication traffic between the UE 102 and the application server 401 for the application 501 is routed through the selected second routing-through means 36. Alternatively, the network controller 10 configures a network such that the communication traffic from the UE 102 is routed through the second routing-through means 36. The IP packet after reaching the platform means 808 is used to determine the application server (application server 401) as the destination on the basis of the correspondence relationship with the application ID held by the platform means 808, and the IP packet having the destination IP address thereof being of the application server 401 is transmitted. In the selection processing of the second routing-through means in the route determination apparatus 20, the second routing-through means is selected such that a time required for the communication traffic reaching is the shortest for the route between the application server 401 for the application 501 and the UE 102, similar to the first to ninth examples above, for example.

The application server 401 for the application 501, when receiving the IP packet from the platform means 808, performs the processing of the application, and after that, returns a result of the processing to the UE 102. Here, a destination of the IP packet for retuning the result of the processing may be the IP address of the sender of the received IP packet. In this case, the platform system is not passed through. This is an effective method in a case that the IP address of the UE is not changed after the user sends the IP packet.

The method for transmitting the IP packet from the application server 401 to the UE 102 includes a method in which the platform means 808 is passed through, besides the method described above. In this case, a combination of the platform means 808 and the UE IP address management system 801 is considered as the platform system 809. The application server 401 for the application 501, when receiving the IP packet including the UE 102 ID from the platform means 808, performs the processing of the application. After that, the application server 401 returns the result of the processing to the UE 102, with the destination of the IP packet thereof being the platform means 808. The platform means 808, when receiving the IP packet from the application server 401, may input the ID of the UE 102 to the UE IP address management system 801 to obtain the IP address of the UE 102, and set the obtained IP address to the destination IP address. This is because even if the user IP address is changed, the UE IP address management system 801 manages the IP address following the change, and therefore, the IP packet can be always returned to the UE 102 even if the IP address of the UE is changed.

In a case that multiple platform means 808 are distributively provided, the platform means 808 is located between the application server 401 and the UE 102, and thus may be considered as a kind of the routing-through means. Therefore, the route determination apparatus 20 holds in advance the platform means 808 such that a time required for the communication traffic reaching is the shortest for the route between the application server 401 for the application 501 and the UE 102. Then, the route determination apparatus 20, if inquired of about the positional information of the UE and the application ID, may select the platform means 808 corresponding to the inquiry.

The tenth example describes the case that the combination for the platform system 809 includes only the platform means 808, or is the combination of the platform means 808 and the UE IP address management system 801, but is not limited thereto. For example, the route determination apparatus 20, the platform means 808, and the UE IP address management system 801 may collectively form the platform system 809.

The tenth example describes the example in which both the communication directed to the UE 102 and the communication directed to the application server 401 are transmitted with the destination IP addresses thereof being of the platform means 808, but this method may not be necessarily used. For example, a method may be used in which the UE 102 inquires of the platform means 808 about the IP address of the application server 401, and the UE 102 rewrites the destination IP address into the IP address obtained by the inquiry. The application server 401 may also inquire of the platform means 808 about the IP address of the UE. In this case, the platform means 808 passes the identifier of the UE or user to the UE IP address management system 801 to confirm the IP address of the UE, and then, returns the confirmed IP address to the application server 401. The application server 401 may set the returned IP address of the UE to the destination IP address to transmit the information to the UE 102.

### (11) Other Examples

A cache server for distributing the content recently used may also be included in a kind of the application server. The application server may include a node for peer-to-peer (P2P) communication. In the case of the P2P, multiple P2P nodes may be associated with the information of the combination of the application ID or content ID and the positional information of the UE.

The application includes any application operating on the UE, and also includes a cloud service such as IaaS, PaaS, and SaaS.

The first to tenth examples described above use the policy that the metric for selecting the gateway is a delay and the gateway is selected through which a delay in the network between the UE and the application server is minimum. However, the metric for selecting the gateway may be others. For example, as the metric, a processing capability or amount of available free resources of the node or gateway to be passed through can be used. Moreover, as the metric, a cost for using the gateway, a cost for linking between the base station and the gateway, and a cost for linking between the gateway and the application server may be used. As the metric, a delay amount may be used which is obtained by adding the above processing capability or free resources state of the node or gateway to be passed through to the metric in the network as described in the first to tenth examples above.

In place of the application ID or the content ID, the identifier of the UE or the identifier of the user mainly using the application may be used. Since the IP address is an address, the UE can be identified if the IP address determined, where a relationship between the IP address and the ID of the UE is held. In this case, the IP address may be considered as the UE identifier.

It is assumed that the UE uses one application in the examples, but in the case where multiple applications are used by a single UE, the application mainly used by the UE or the application greatly affected by the delay may be dealt with as a representative application.

As the attribute information of the radio base station, besides the radio base station ID, a latitude and longitude, location address, and IP address of the radio base station may be used, for example. If roaming is performed, instead of the ID of the radio base station used by the UE, an ID of a visited network may be used. If roaming is performed, the entire visited network is far from the network used by the UE in many cases, rather than that individual radio base stations indicate their positions. For this reason, even if the entire visited network is represented as a lump, a geographical position of the UE can be approximately identified. Therefore, a gateway (P-GW) near the visited network may be selected. For example, assume that P-GWs are provided in Tokyo and Okinawa, an S-GW of a mobile network in Taiwan is connected with the P-GW in Okinawa at the shortest distance, and an application server is provided in Okinawa, and in this circumstance, a UE using the application is located in Taiwan. If Tokyo is selected for the P-GW in this case, the communication traffic reciprocates between Okinawa and Tokyo, but if Okinawa is selected for the P-GW, the reciprocated communication traffic between Okinawa and Tokyo is not necessary. Therefore the optimal gateway as indicated in Table 1 may be the P-GW in Okinawa, for example.

The first to tenth examples described above describes that the positional information of the UE 102 is used as the method of using the ID, attribute and the like of the radio base station. Taking into consideration that after a radio base station is determined, in association with it the S-GW is determined, the S-GW being used by the UE can be used as the positional information of the UE. For example, assume that the S-GW being used by the UE can be found by inquiring of a home subscriber server (HSS, see reference literatures 1 and 2 above) or the like. In this case, the route determination apparatus 20 can inquire of the HSS to find the S-GW being used by the UE 102. To be more specific, in the table representing the correspondence relationship, the ID of the S-GW, instead of the radio base station ID, may be used as a parameter for selecting the gateway (P-GW). In this case, the change in the S-GW used by the UE may be used as a trigger for the operation like that of in the first example. The third and subsequent examples describe that the optimal gateway or the like corresponding to the application ID and the positional information of the UE is selected basically similar to in the first example. Note that in order to determine the S-GW which may be considered as a kind of the positional information of the UE, an inquiry may be made to the HSS by means of the ID of the UE to determine the S-GW as described in the second example. Any of the positional information of the UE associated with the position of the UE can be used.

In the examples, the S-GW, which is originally determined depending on the radio base station used by the UE and has no concern with the P-GW selection, is not specifically mentioned. Note that in a system in which the S-GW can be freely selected, a combination of the S-GW and the P-GW may be determined for the combination of the ID of the application used by the UE and the positional information of the UE. In a system in which if an S-GW is determined, a P-GW associated with the S-GW is determined, the S-GW may be determined based on the application ID and the positional information of the user. Alternatively, IDs of the MME and TA being used by the UE are also linked to the positional information of the UE, and therefore, these IDs can be used as the positional information of the UE.

In the description of the examples, LTE/SAE is used, but the same can be applied even in a case that a system of the third generation is used by replacing the P-GW with a gateway GPRS support node (GGSN) as the gateway.

In the first to tenth examples or the like described above, when the UE 102 moves and the radio base station 202 to be connected changes, the change triggers to inquire of the route determination apparatus 20 about the optimal gateway to select the gateway. Note that with a change in a state of the application server 401 for the application 501, or triggered by a change in the correspondence table held by the route holding and calculating unit 21 in the route determination apparatus 20, the gateway may be selected. The state of the application server 401 for the application 501 refers to newly adding or removing the application server for application 501.

Note that a change in the S-GW, network controller, or tracking area (TA) to be used, or in the IP address of the UE and the like may trigger to select the optimal route, for example.

The processing regarding authentication and charging may be included. For example, a user or UE to use the route determination apparatus 20 is authenticated in order to refer to the route determination apparatus 20, and thereafter, the user is made to use the route determination apparatus 20, where the user may be charged before or after the user uses the apparatus.

Note that the input identifier and information may be converted into a number, to which a hash function is applied to convert into hash values, such that the correspondence relationship is held in those values. With this configuration, the value to search for is not in a form of the combination of the application ID and the positional information, but one numeral item, and thus, the processing of selecting the gateway or the like may become faster.

Note that a local gateway provided near the radio base station may be used as a function of the P-GW. The number of gateways selected by the route determination apparatus 20 may not be necessarily one. For example, a first priority gateway and a second priority gateway may be selected for the information of the combination of the ID of the application used by the user and the radio base station ID. Additionally, multiple gateways even having the same priority may be used differently depending on a load state. A method of alternately using multiple gateways (round robin scheme) or the like may be used. Further, not only the gateways but also multiple radio base stations and multiple application servers may be selected.

As described above, selecting the gateway for processing depending on the application ID allows the gateway for the application having many processes to be served by a gateway higher in processing capability, having an effect that the load on the gateway can be efficiently distributed.

The route determination apparatus 20 may include input means for accepting rewrite of the content of the data included in the route holding and calculating unit 21, for example, the correspondence relationship of the data indicated in Table 1 to Table 19. For this reason, the route determination apparatus 20 may be provided with an interface at an application level, or an application programming interface (API) to change the correspondence relationship in the table. In this case, if an application provider newly provides an application server, an application ID and IP address thereof may be notified to the route determination apparatus 20. The route determination apparatus 20 collects a time required for the IP packet to reach an apparatus with the IP address from the P-GW as measurement data in advance, on the basis of the newly generated application server IP address. Then, the route determination apparatus 20 calculates, based on the measurement data, which P-GW and which application server are optimal to be used for a certain base station and a certain application ID, by means of the control unit 22. Based on a calculation result, the P-GW corresponding to the application ID and the radio base station ID can be updated.

Other identifiers such as a temporarily assigned identifier, or a temporary mobile subscriber identifier (TMSI) may be used, without limitation on the IMSI.

### 5. Second Exemplary Embodiment

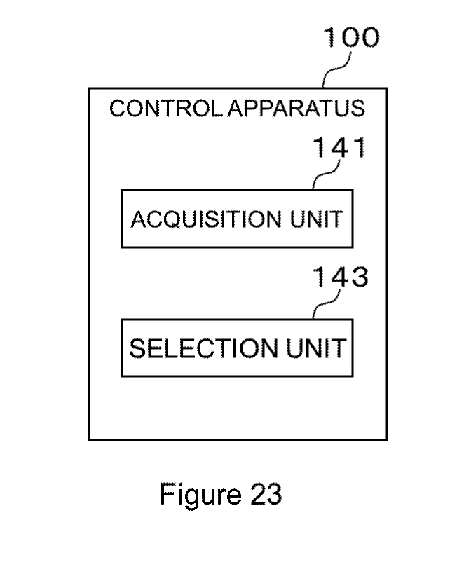

Next, a description is given of a second exemplary embodiment of the present invention with reference to FIG. 23. The first exemplary embodiment described above is a concrete exemplary embodiment, but the second exemplary embodiment is a more generalized exemplary embodiment.

### 5.1. Configuration of Control Apparatus

First, a description is given of an example of a configuration of a control apparatus 100 according to the second exemplary embodiment with reference to FIG. 23. FIG. 23 is a block diagram illustrating an example of a schematic configuration of the control apparatus 100 according to the second exemplary embodiment. With reference to FIG. 23, the control apparatus 100 includes an acquisition unit 141 and a selection unit 143. Concrete operations of the acquisition unit 141 and the selection unit 143 are described below.

The acquisition unit 141 and the selection unit 143 may be implemented by a baseband (BB) processor and/or other processors or the like. The control apparatus 100 may include a memory storing a program (instructions) and one or more processors capable of executing the program (instructions), and one or more processors may execute the program to perform the operations of the acquisition unit 141 and selection unit 143. The program may be a program causing the processor to execute the operations of the acquisition unit 141 and selection unit 143.

### 5.2. Technical Feature

Next, a description is given of a technical feature in the second exemplary embodiment.

In the second exemplary embodiment, the control apparatus 100 (acquisition unit 141) acquires evaluation information of multiple routes configured between an application server and a user apparatus, the application server providing an application service via a mobile network, and the evaluation information being based on a metric between the application server and a node included in the mobile network. The control apparatus (selection unit 143) selects at least one route from among the multiple routes, based on the evaluation information.

For example, the control apparatus 100 may be the control apparatus 100 according to the first exemplary embodiment described above. To be more specific, the acquisition unit 141 may perform the operation of the acquisition unit 131 according to the first exemplary embodiment described above. The selection unit 143 may perform the operation of the selection unit 133 according to the first exemplary embodiment described above.

Note that the operation of the control apparatus 100 is not limited to the operation example of the control apparatus 100 according to the first exemplary embodiment described above.

Hereinabove, the second exemplary embodiment is described. According to the second exemplary embodiment, by selecting the route based on the evaluation information based on the metric between the application server and the node included in the mobile network, a more appropriate route can be selected as compared with a case of considering a route only between the user apparatus and the node, for example. For example, in view of communication delay reduction, resource optimization and the like, it is possible to connect a server providing an application service via a mobile network and a user apparatus through an appropriate route.

### 6. Other Exemplary Embodiments

Hereinabove, the exemplary embodiments of the present invention are described, but the present invention is not limited to the above exemplary embodiments. It will be appreciated by those skilled in the art that these exemplary embodiments are merely examples, and various modifications may be made without departing from a scope and spirit of the present invention.

For example, the steps in the processing described herein may not be necessarily performed in the order described in a sequence diagram in time series. For example, the steps in the processing may be performed in an order different from the order described in the sequence diagram or in parallel. A part of the steps may be deleted, and further step may be added to the processing.

An apparatus including the components of the control apparatus described herein (e.g., acquisition unit, selection unit and/or provision unit) may be provided (e.g., one or more apparatuses (or units) of multiple apparatuses (or units) constituting the control apparatus, or a module for one of the above multiple apparatuses (or units)). A method including processing of the above components may be provided, and a program causing the processor to execute the processing of the above components may be provided. A non-transitory computer readable medium storing the program may be provided. Needless to say, such an apparatus, module, method, program, and non-transitory computer readable medium are also covered by the present invention.

Some or all of the exemplary embodiments may be described as the following Supplementary Notes, but are not limited thereto.

### (Supplementary Note 1)

A control apparatus including:

an acquisition unit configured to acquire evaluation information of multiple routes configured between a server and a user apparatus, the server providing at least one application service via a mobile network including at least one radio base station node and at least one connection node for connecting to other network, and the evaluation information being based on a metric between the server and a node included in the mobile network; and

a selection unit configured to select a route that defines at least one node of the at least one radio base station node and the at least one connection node from among the multiple routes, based on the evaluation information.

### (Supplementary Note 2)

The control apparatus according to Supplementary Note 1, wherein selecting the route that defines at least one node of the at least one radio base station node and the at least one connection node includes selecting a node virtualized in the mobile network.

### (Supplementary Note 3)

The control apparatus according to Supplementary Note 1 or 2, wherein selecting the route that defines at least one node of the at least one radio base station node and the at least one connection node includes selecting at least one server of multiple servers providing the application service.

### (Supplementary Note 4)

The control apparatus according to any one of Supplementary Notes 1 to 3, wherein the evaluation information includes information regarding an optimal route having an optimal metric among the multiple routes.

### (Supplementary Note 5)

The control apparatus according to Supplementary Note 4, wherein the information regarding the optimal route includes information for identifying the server or node connected on the optimal route.

### (Supplementary Note 6)

The control apparatus according to Supplementary Note 4 or 5, wherein the information regarding the optimal route includes information for identifying the application service provided through the optimal route.

### (Supplementary Note 7)

The control apparatus according to any one of Supplementary Notes 1 to 6, wherein the acquisition unit acquires the evaluation information based on identification information regarding the application service.

### (Supplementary Note 8)

The control apparatus according to any one of Supplementary Notes 1 to 7, wherein the acquisition unit acquires the evaluation information based on identification information regarding the node included in the mobile network.

### (Supplementary Note 9)

The control apparatus according to any one of Supplementary Notes 1 to 8, wherein the acquisition unit acquires the evaluation information based on positional information of the user apparatus.

### (Supplementary Note 10)

The control apparatus according to any one of Supplementary Notes 1 to 6, wherein the acquisition unit acquires the evaluation information by evaluating the multiple routes based on the metric between the server and the node included in the mobile network to generate the evaluation information.

### (Supplementary Note 11)

The control apparatus according to any one of Supplementary Notes 1 to 10, further comprising a provision unit configured to provide information regarding the route selected based on the evaluation information to the node included in the mobile network.

### (Supplementary Note 12)

The control apparatus according to Supplementary Note 11, wherein the provision unit provides information regarding the route selected based on the evaluation information to a control node included in the mobile network.

### (Supplementary Note 13)

The control apparatus according to Supplementary Note 11, wherein the provision unit provides the information regarding the route selected based on the evaluation information to the sever or node connected on the route selected based on the evaluation information.

### (Supplementary Note 14)

A method including:

acquiring evaluation information of multiple routes configured between a server and a user apparatus, the server providing at least one application service via a mobile network including at least one radio base station node and at least one connection node for connecting to other network, and the evaluation information being based on a metric between the server and a node included in the mobile network; and

selecting a route that defines at least one node of the at least one radio base station node and the at least one connection node from among the multiple routes, based on the evaluation information.

### (Supplementary Note 15)

A program product causing a processor to execute:

acquiring evaluation information of multiple routes configured between a server and a user apparatus, the server providing at least one application service via a mobile network including at least one radio base station node and at least one connection node for connecting to other network, and the evaluation information being based on a metric between the server and a node included in the mobile network; and

selecting a route that defines at least one node of the at least one radio base station node and the at least one connection node from among the multiple routes, based on the evaluation information.

### (Supplementary Note 16)

A non-transitory computer readable medium storing a program, the program causing a processor to execute:

acquiring evaluation information of multiple routes configured between a server and a user apparatus, the server providing at least one application service via a mobile network including at least one radio base station node and at least one connection node for connecting to other network, and the evaluation information being based on a metric between the server and a node included in the mobile network; and

selecting a route that defines at least one node of the at least one radio base station node and the at least one connection node from among the multiple routes, based on the evaluation information.

It is possible to, in providing application service via the mobile network, connect between the server providing the application service via the mobile network and the user apparatus through an appropriate route.

What is claimed is:

1. A control apparatus comprising:
a memory storing a program; and
one or more processors configured to execute the program to:
acquire evaluation information of multiple routes configured between a server and a user apparatus, the server providing at least one application service via a mobile network including at least one radio base station node and at least one connection node for connecting to other network, and the evaluation information being based on a metric between the server and a node included in the mobile network; and
select a route that defines at least one node of the at least one radio base station node and the at least one connection node from among the multiple routes, based on the evaluation information.

2. The control apparatus according to claim 1, wherein selecting the route that defines at least one node of the at least one radio base station node and the at least one connection node includes selecting a node virtualized in the mobile network.

3. The control apparatus according to claim 1, wherein selecting the route that defines at least one node of the at least one radio base station node and the at least one connection node includes selecting at least one server of multiple servers providing the application service.

4. The control apparatus according to claim 1, wherein the evaluation information includes information regarding an optimal route having an optimal metric among the multiple routes.

5. The control apparatus according to claim 4, wherein the information regarding the optimal route includes information for identifying the server or node connected on the optimal route.

6. The control apparatus according to claim 4, wherein the information regarding the optimal route includes information for identifying the application service provided through the optimal route.

7. The control apparatus according to claim 1, wherein the one or more processors configured to execute the program to acquire the evaluation information based on identification information regarding the application service.

8. The control apparatus according to claim 1, wherein the one or more processors configured to execute the program to acquire the evaluation information based on identification information regarding the node included in the mobile network.

9. The control apparatus according to claim 1, wherein the one or more processors configured to execute the program to acquire the evaluation information based on positional information of the user apparatus.

10. The control apparatus according to claim 1, wherein the one or more processors configured to execute the program to acquire the evaluation information by evaluating the multiple routes based on the metric between the server and the node included in the mobile network to generate the evaluation information.

11. The control apparatus according to claim 1, the one or more processors configured to execute the program to provide information regarding the route selected based on the evaluation information to the node included in the mobile network.

12. The control apparatus according to claim 11, wherein the one or more processors configured to execute the program to provide information regarding the route selected based on the evaluation information to a control node included in the mobile network.

13. The control apparatus according to claim 11, wherein the one or more processors configured to execute the program to provide the information regarding the route selected based on the evaluation information to the sever or node connected on the route selected based on the evaluation information.

14. A method including:
acquiring evaluation information of multiple routes configured between a server and a user apparatus, the server providing at least one application service via a mobile network including at least one radio base station node and at least one connection node for connecting to other network, and the evaluation information being based on a metric between the server and a node included in the mobile network; and
selecting a route that defines at least one node of the at least one radio base station node and the at least one connection node from among the multiple routes, based on the evaluation information.

15. A non-transitory computer readable medium storing a program, the program causing a processor to execute:
acquiring evaluation information of multiple routes configured between a server and a user apparatus, the server providing at least one application service via a mobile network including at least one radio base station node and at least one connection node for connecting to other network, and the evaluation information being based on a metric between the server and a node included in the mobile network; and
selecting a route that defines at least one node of the at least one radio base station node and the at least one connection node from among the multiple routes, based on the evaluation information.
